(19) United States
(12) Patent Application Publication
(10) Pub. No.: US 2004/0223213 A1
(43) Pub. Date: Nov. 11, 2004

(54) Microscopic observing apparatus and probe microscope

(76) Inventors: Hiroya Fukuyama, Tokyo (JP); Mitsuhiro Hara, Tokyo (JP); Yoshihiro Kawano, Tokyo (JP); Keiji Shimizu, Tokyo (JP)

Correspondence Address: KENYON & KENYON, 1500 K STREET, N.W., SUITE 700, WASHINGTON, DC, 20005, US

(21) Appl. No.: 10/828,473

(22) Filed: Apr. 21, 2004

(30) Foreign Application Priority Data
Apr. 25, 2003 (JP) 2003-121590
Feb. 20, 2004 (JP) 2004-44606

(51) Int. Cl. G02B 21/00; G02B 21/18; G02B 21/26

(52) U.S. Cl. 359/368; 359/391

(57) ABSTRACT

In a microscopic observing apparatus, the optical axis of a probe microscope is placed between the two optical axes of a stereoscopic microscope. In another microscopic observing apparatus, the microscopic observing apparatus includes a guide mechanism that guides the probe microscope and the stereoscopic microscope, a connecting member that maintains a constant spacing between optical axes of the probe microscope and the stereoscopic microscope, a right stopper that restricts further movement of the stereoscopic microscope when the position of the optical axis of the stereoscopic microscope matches a center position on the guide rail; and a left stopper that restricts further movement of the probe microscope when the position of the optical axis of the probe microscope matches the center position.

Priority is claimed on Japanese Unexamined Patent Application, First Publication No. 2003-121590, filed Apr. 25, 2003, and Japanese Unexamined Patent Application, First Publication No. 2004-44606, filed Feb. 20, 2004, the contents of which are incorporated herein by reference.

### BACKGROUND OF THE INVENTION

1. Field of the Invention

The present invention relates to a microscopic observing apparatus and to a probe microscope and, in particular, to technology that can ensure an excellent stereoscopic microscope visual field.

The present invention also relates to a microscopic observing apparatus that is provided with a microscope having a relatively high magnification optical system and a microscope having a low magnification optical system.

2. Description of Related Art

In the fields of medicine and biology, when performing biological tests in accompaniment to microscopic observation, conventionally, organs, tissue, and cells that are the subject of observation are extracted from an experimental animal, and are then placed on a specimen stage of a microscope and observed. However, there are cases in which the behavior of organs, tissue, and cells differs between a state in which these are in an individual organism and a state in which they have been cut out from the individual organism. Therefore, in order to accurately observe natural behavior, it is preferable to perform what is known as in-vivo observation in which the individual organism remains alive and the portion that is being observed is not cut out from the individual organism.

An example of an apparatus that makes this in-vivo observation possible is the probe microscope (i.e., optical scanning microscope) disclosed in Japanese Unexamined Patent Application, First Publication No. 2002-272674. A probe microscope is formed by reducing the size of a confocal microscope so as to form a probe type of microscope. This probe microscope is used by being inserted into a body cavity thereby enabling living tissue to be observed directly in its natural state.

Because the size of the field of vision of a probe microscope is extremely narrow, namely, between several tens of μm and several hundred μm, it is preferable that a probe microscope is used in combination with an auxiliary microscope (i.e., a stereoscopic microscope, a normal microscope, a video microscope or the like) having a wider field of vision. In this case, firstly, the observation position is designated by performing macro observation using the auxiliary microscope, and then the probe microscope is positioned on that observation position so that micro observation of a desired observation position is performed.

### SUMMARY OF THE INVENTION

(Microscopic Observing Apparatus and Probe Microscope)

A microscopic observing apparatus of the present invention is provided with a probe microscope and a stereoscopic microscope, wherein an optical axis of the probe microscope is placed between two optical axes of the stereoscopic microscope.

According to this microscopic observing apparatus, because a dead angle is formed between the two optical axes forming the field of vision of the stereoscopic microscope, by making the optical axis of the probe microscope come inside this dead angle, it is possible to suppress the probe microscope from intruding into the field of vision of the stereoscopic microscope as much as possible.

Accordingly, the field of vision of the stereoscopic microscope can be prevented as far as possible from being blocked, thereby allowing an excellent field of vision to be ensured.

It is preferable that a probe body housing an optical system of the probe microscope is supported by a first supporting member that avoids the two optical axes of the stereoscopic microscope.

In this case, the first supporting member can be prevented from intruding into the field of vision of the stereoscopic microscope.

Accordingly, the field of vision of the stereoscopic microscope can be made even better.

It is preferable that a probe body housing an optical system of the probe microscope is supported by a second supporting member that is formed from a transparent material.

In this case, even if the second supporting member intrudes into the field of vision of the stereoscopic microscope, because the second supporting member is transparent, the field of view is not obstructed.

Accordingly, the field of vision of the stereoscopic microscope can be made even better.

The probe microscope of the present intention is used in combination with a stereoscopic microscope, wherein an optical axis of the probe microscope is positioned between two optical axes of the stereoscopic microscope.

According to this probe microscope, because a dead angle is formed between the two optical axes forming the field of vision of the stereoscopic microscope, by making the optical axis of the probe microscope come inside this dead angle, it is possible to suppress the probe microscope from intruding into the field of vision of the stereoscopic microscope as much as possible.

Accordingly, the field of vision of the stereoscopic microscope can be prevented as far as possible from being blocked, thereby allowing an excellent field of vision to be ensured.

(Microscopic Observing Apparatus)

The microscopic observing apparatus of the present invention is provided with a probe microscope; an auxiliary microscope; a specimen stage on which is placed a subject of observation that is to be observed using the probe microscope and the auxiliary microscope, and that allows an absolute position of the subject of observation to be adjusted; a first guide that guides the probe microscope and the auxiliary microscope in one direction above the specimen stage; a connecting member that maintains a constant spacing between optical axes of the probe microscope and the auxiliary microscope; a first restricting member that restricts further movement of the auxiliary microscope when a position of an optical axis of the auxiliary microscope matches a predetermined position on the first guide; and a second restricting member that restricts further movement of the probe microscope when a position of an optical axis of the probe microscope matches the predetermined position.

According to this microscopic observing apparatus, firstly, the auxiliary microscope is moved along the first guide so as to approach a position of the subject of observation placed on the specimen stage. When the position of the optical axis of the auxiliary microscope arrives at a predetermined position on the first guide, further movement is restricted by the first restricting member and the auxiliary microscope stops. In this stopped state, macro observation is performed by the auxiliary microscope and, if necessary, the specimen stage is operated and the absolute position of the subject of observation is adjusted such that the desired observation field of vision can be obtained. As a result of this operation, the relative positions between the predetermined position (namely, the position of the optical axis of the auxiliary microscope) and the specimen stage at the time when the desired observation field of vision is obtained are accurately set.

Next, the probe microscope is then moved along the first guide so as to approach the position of the subject of observation. Because the auxiliary microscope at this time is connected to the probe microscope via the connecting member, the auxiliary microscope is automatically withdrawn from above the specimen stage. When the position of the optical axis of the probe microscope arrives at the predetermined position on the first guide, further movement is restricted by the second restricting member and the probe microscope stops. As a result, the position of the optical axis when performing micro observation using the probe microscope can be automatically matched with the position of the optical axis when macro observation is performed using the auxiliary microscope (namely, with the predetermined position).

In this way, according to the microscopic observing apparatus of the present invention, it is possible to automatically match the position of the optical axis when performing micro observation using the probe microscope with the position of the optical axis when performing macro observation using the auxiliary microscope simply by moving the auxiliary microscope and the probe microscope along the first guide and then stopping the auxiliary microscope and probe microscope in accordance with the first restricting member and the second restricting member.

Accordingly, when switching from macro observation to micro observation using a probe microscope having a relatively high magnification optical system and an auxiliary microscope having a low magnification optical system, the probe microscope can be easily and accurately positioned at the desired observation position.

The microscopic observing apparatus of the present invention is provided with a probe microscope; an auxiliary microscope; a specimen stage on which is placed a subject of observation that is to be observed using the probe microscope and the auxiliary microscope, and that allows an absolute position of the subject of observation to be adjusted; a first microscope holding member that holds the auxiliary microscope and the probe microscope such that they can be rotated so as to pass above the specimen stage; and a third restricting member that restricts further rotation of the auxiliary microscope when an optical axis position of the auxiliary microscope matches a predetermined position on the specimen stage, and that restricts further rotation of the probe microscope when an optical axis position of the probe microscope matches the predetermined position.

According to this microscopic observing apparatus, firstly, the first microscope holding member is rotated such that the auxiliary microscope approaches a position of the subject of observation that is placed on the specimen stage. When the position of the optical axis of the auxiliary microscope arrives at a predetermined position on the specimen stage, further rotation is restricted by the third restricting member and the auxiliary microscope stops. In this stopped state, macro observation is performed by the auxiliary microscope and, if necessary, the specimen stage is operated and the absolute position of the subject of observation is adjusted such that the desired observation field of vision can be obtained. As a result of this operation, the relative positions between the predetermined position (namely, the position of the optical axis of the auxiliary microscope) and the specimen stage at the time when the desired observation field of vision is obtained are accurately set.

Next, the first microscope holding member is then rotated such that the probe microscope approaches the position of the subject of observation. Because the auxiliary microscope at this time is essentially connected to the probe microscope via the first microscope holding member, the auxiliary microscope is automatically withdrawn from above the specimen stage. When the position of the optical axis of the probe microscope arrives at the predetermined position on the specimen stage, further rotation is restricted by the third restricting member and the probe microscope stops. As a result, the position of the optical axis when performing micro observation using the probe microscope can be automatically matched with the position of the optical axis when macro observation is performed using the auxiliary microscope (namely, with the predetermined position).

In this way, according to the microscopic observing apparatus of the present invention, it is possible to automatically match the field of vision when performing micro observation using the probe microscope with the observation field of vision when performing macro observation using the auxiliary microscope simply by rotating the auxiliary microscope and the probe microscope using the first microscope holding member, and then stopping the auxiliary microscope and probe microscope at their respective observation positions in accordance with the third restricting member. Accordingly, when switching from macro observation to micro observation using a probe microscope having a relatively high magnification optical system and an auxiliary microscope having a low magnification optical system, the probe microscope can be easily and accurately positioned at the desired observation position.

The microscopic observing apparatus of the present invention is provided with a probe microscope; an auxiliary microscope; a specimen stage on which is placed a subject of observation that is to be observed using the probe microscope and the auxiliary microscope, and that allows an absolute position of the subject of observation to be adjusted; a second guide that extends between the probe microscope and the auxiliary microscope; a fourth restricting member that restricts further movement of the specimen stage when a predetermined position on the specimen stage arrives at an optical axis position of the auxiliary microscope; and a fifth restricting member that restricts further movement of the specimen stage when the predetermined position on the specimen stage arrives at an optical axis position of the probe microscope, wherein the specimen stage has a rough movement stage that moves along the second guide, and a precise movement stage those relative position relative to the rough movement stage can be precisely adjusted and on which the subject of observation is placed, and the predetermined position is set for the rough movement stage.

According to this microscopic observing apparatus, firstly, the specimen stage on which the subject of observation has been placed is moved along the second guide so as to approach an observation position of the auxiliary microscope. When a predetermined position set on the rough movement stage of the specimen stage arrives at the position of the optical axis of the auxiliary microscope, further movement is restricted by the fourth restricting member and the specimen stage stops. In this stopped state, macro observation is performed by the auxiliary microscope and, if necessary, the precise movement stage is operated and the absolute position of the subject of observation is adjusted such that the desired observation field of vision can be obtained. As a result of this operation, all the relative positions between the precise movement stage, the predetermined position on the rough movement stage, and the position of the optical axis of the auxiliary telescope at the time when the desired observation field of vision is obtained are accurately set.

Next, the specimen stage on which the subject of observation has been placed is then moved along the second guide so as to approach an observation position of the probe microscope. When the predetermined position set on the rough movement stage of the specimen stage arrives at the position of the optical axis of the probe microscope, further movement is restricted by the fifth restricting member and the specimen stage stops. As a result, the position of the optical axis when performing micro observation using the probe microscope can be automatically matched with the position of the optical axis that is focused on the precise movement stage when macro observation is performed using the auxiliary microscope.

In this way, according to the microscopic observing apparatus of the present invention, it is possible to automatically match the field of vision when performing micro observation using the probe microscope with the observation field of vision when performing macro observation using the auxiliary microscope simply by moving the specimen stage along the second guide and then stopping the specimen stage in accordance with the fourth restricting member and the fifth restricting member. Accordingly, when switching from macro observation to micro observation using a probe microscope having a relatively high magnification optical system and an auxiliary microscope having a low magnification optical system, the probe microscope can be easily and accurately positioned at the desired observation position.

It is preferable that an aperture portion that penetrates the specimen stage in a vertical direction is formed in the specimen stage, and the probe microscope and the stereoscopic microscope are able to observe the subject of observation from the underside of the specimen stage via the aperture portion.

In this case, because it is possible to make an observation by looking up at the specimen stage through the aperture portion from below the specimen stage, when, for example, performing in-vivo observation of the internal organs of an experimental animal by opening up the abdomen and the like thereof, it is possible to observe the experimental animal as it is in a natural attitude without having to turn the experimental animal over.

Accordingly, it is possible to perform in-vivo observation that is nearer to a natural state because there is no need to change the state of the experimental animal by turning the experimental animal over.

The microscopic observing apparatus of the present invention is provided with a probe microscope; an auxiliary microscope; a specimen stage on which is placed a subject of observation that is to be observed using the probe microscope and the auxiliary microscope, wherein an aperture portion that penetrates the specimen stage in a vertical direction is formed in the specimen stage, and the microscopic observing apparatus is provided with: a second microscope holding member that holds the probe microscope and the auxiliary microscope below the specimen stage such that optical axes of the probe microscope and the auxiliary microscope penetrate the aperture portion and intersect at a position on the subject of observation; and an adjusting device that adjusts relative positions between the specimen stage and the auxiliary microscope and probe microscope.

According to this microscopic observing apparatus, firstly a subject of observation is placed on the specimen stage and macro observation is performed using the auxiliary microscope. At this time, if necessary, the adjusting device is operated and the position of the specimen stage is adjusted such that the desired observation field of vision is obtained. As a result of this operation, relative positions between the optical axis of the auxiliary microscope and the specimen stage at the time the desired observation field of vision is obtained can be accurately set.

Next, micro observation is performed by the probe microscope, however, because the optical axis of the probe microscope and the optical axis of the auxiliary microscope have been set in advance so as to intersect at a position on the subject of observation, the positioning operation to match the optical axis position of the probe microscope with the optical axis position of the auxiliary microscope is unnecessary. Moreover, as is described above, the relative positions between the optical axis of the auxiliary microscope and the specimen stage have already been accurately positioned. Accordingly, any further operation to position the specimen stage is unnecessary, and micro observation using the probe microscope can be performed in this state.

Furthermore, because it is possible to make an observation by looking up at the specimen stage through the aperture portion from below the specimen stage, when, for example, performing in-vivo observation of the internal organs of an experimental animal by opening up the abdomen and the like thereof, it is possible to observe the experimental animal as it is in a natural attitude without having to turn the experimental animal over.

In this way, according to the above described microscopic observing apparatus of the present invention, because the probe microscope and the auxiliary microscope are supported by the second microscope holding member such that the optical axes of each intersect at a position on the subject of observation, when performing macro observation using the auxiliary microscope, once the relative position of the specimen stage has been set relative to the optical axis of the auxiliary microscope using the adjusting device, at the same time, the relative position of the specimen stage is also accurately set relative to the optical axis of the probe microscope. Accordingly, when switching from macro observation to micro observation using the probe microscope having a relatively high magnification optical system and the auxiliary microscope having a low magnification optical system, the probe microscope can be easily and accurately positioned at the desired observation position.

Furthermore, when, for example, performing in-vivo observation of the internal organs of an experimental animal by opening up the abdomen and the like thereof, it is possible to observe the experimental animal as it is in a natural attitude without having to turn the experimental animal over. Accordingly, it is possible to perform in-vivo observation that is nearer to a natural state because there is no need to change the state of the experimental animal by turning the experimental animal over.

It is preferable that the microscopic observing apparatus is provided with a first laser light irradiation device that irradiates laser light onto a position where the optical axis of the auxiliary microscope strikes the subject of observation.

In this case, by confirming the position on the subject of observation where laser light emitted from the first laser light irradiation device is irradiated using the naked eye or the auxiliary microscope, it is possible to visually confirm the position of the optical axis of the auxiliary microscope relative to the subject of observation.

Accordingly, the operation to position the optical axis of the auxiliary microscope during macro observation can be performed more easily and in a shorter time.

The microscopic observing apparatus of the present invention includes: a probe microscope; an auxiliary microscope having a lower magnification optical system than that of the probe microscope; a specimen stage on which is placed a subject of observation that is to be observed using the probe microscope and the auxiliary microscope, and that allows an absolute position of the subject of observation to be adjusted; and a second laser light irradiation device that irradiates laser light that is coaxial with the optical axis of the probe microscope onto the subject of observation, wherein the auxiliary microscope is located such that the laser light irradiated onto the subject of observation is visible.

According to this microscopic observing apparatus, firstly, macro observation is performed using the auxiliary microscope while laser light from the second laser light irradiation device is irradiated onto the subject of observation on the specimen stage. The specimen stage is then operated such that the laser light strikes the desired observation position while the laser light irradiation position is being confirmed using the auxiliary microscope. As a result of this operation, because it is possible for the optical axis of the probe microscope to be accurately positioned relative to the desired observation position, micro observation using the probe microscope can be subsequently performed.

In this way, according to the microscopic observing apparatus of the present invention, by providing the apparatus with the second laser light irradiation device, because it is possible to carry out the operation to position the optical axis of the probe microscope while visually confirming the optical axis position of the probe microscope relative to the observation position of the subject of observation using the auxiliary microscope, the operation to position the optical axis in order to perform micro observation can be performed more simply and in a shorter time.

Accordingly, when switching from macro observation to micro observation using the probe microscope having a relatively high magnification optical system and the auxiliary microscope having a low magnification optical system, the probe microscope can be easily and accurately positioned at the desired observation position.

It is preferable that the auxiliary microscope is a video microscope including a CCD camera with a macro lens, and that is held together with the probe microscope by a third microscope holding member.

In this case, by implying a video microscope as the auxiliary microscope the size of the auxiliary microscope can be reduced.

Accordingly, it is possible for both the auxiliary microscope and the probe microscope to be held by the third microscope holding member, and for the size of the apparatus as a whole to be reduced.

When the subject of observation is a fluorescent sample, it is preferable that an excitation wavelength is used for the wavelength of the laser light.

In this case, by irradiating laser light having an excitation wavelength onto the observation position of the subject of observation, positioning can be performed using fluorescent observation in addition to normal observation.

The microscopic observing apparatus of the present invention is provided with a probe microscope; an auxiliary microscope; a specimen stage on which is placed a subject of observation that is to be observed using the probe microscope and the auxiliary microscope; a fourth microscope holding member that holds the probe microscope and that allows a position of an optical axis of the probe microscope to be adjusted relative to a predetermined position on the specimen stage; a fifth microscope holding member that holds the auxiliary microscope such that an optical axis of the auxiliary microscope intersects with an optical axis of the probe microscope; a rotation mechanism that rotatably supports the fifth microscope holding member; and a sixth restricting member that stops a rotation of the fifth microscope holding member when the fifth microscope holding member is rotated by the rotation mechanism and an optical axis of the auxiliary microscope matches the predetermined position.

According to this microscopic observing apparatus, firstly, the fifth microscope holding member is rotated such that the optical axis of the auxiliary microscope is directed towards the predetermined position. At the point when the optical axis of the auxiliary microscope matches the predetermined position, the sixth restricting member is operated so that further rotation of the fifth restricting member is stopped. Macro observation of the subject of observation on the specimen stage is then performed using the auxiliary microscope that has been positioned in this manner. The fourth microscope holding member is then operated while the relative positions between the observation position of the subject of observation in the visual field of the auxiliary microscope and the probe microscope are being confirmed from an oblique angle, and the optical axis position of the probe microscope is matched to the observation position. At this time, because the position of the distal end of the probe microscope can be viewed using the auxiliary microscope such that it can be viewed from an oblique angle, the positioning operation can be performed easily.

Next, when micro observation is performed using the probe microscope, if necessary, by releasing the fixing action of the sixth restricting member and rotating the rotating mechanism, it is possible to withdraw the fifth microscope holding member together with the auxiliary microscope from an area above the subject of observation.

In this way, according to the microscopic observing apparatus of the present invention, because the position of the distal end of the probe microscope can be viewed using the auxiliary microscope such that it can be viewed from an oblique angle, the positioning operation can be performed easily. Accordingly, when switching from macro observation to micro observation using the probe microscope having a relatively high magnification optical system and the auxiliary microscope having a low magnification optical system, the probe microscope can be easily and accurately positioned at the desired observation position.

Moreover, during the micro observation using the probe microscope, if necessary, it is possible to withdraw the fifth microscope holding member together with the auxiliary microscope from the area above the subject of observation. Accordingly, during micro observation it is possible to secure a large working space.

The microscopic observing apparatus of the present invention is provided with a probe microscope; an auxiliary microscope; a specimen stage on which is placed a subject of observation that is to be observed using the probe microscope and the auxiliary microscope; a sixth microscope holding member that holds the probe microscope and that allows a position of an optical axis of the probe microscope to be adjusted relative to a predetermined position on the specimen stage; a seventh microscope holding member that holds the auxiliary microscope such that it can be rotated so as to pass through a position above the probe microscope that is placed at the predetermined position; and a seventh restricting member that stops a rotation of the seventh microscope holding member when an optical axis of the auxiliary microscope matches the predetermined position, wherein the auxiliary microscope is a stereoscopic microscope, and when the stereoscopic microscope and the probe microscope are both placed above the predetermined position, the probe microscope is placed within a dead angle region of the stereoscopic microscope.

According to this microscopic observing apparatus, firstly, the seventh microscope holding member is rotated such that the optical axis of the auxiliary microscope is directed towards the predetermined position. At the point when the optical axis of the auxiliary microscope matches the predetermined position, the seventh restricting member is operated so that further rotation of the seventh restricting member is stopped. Subsequently, because the probe microscope is automatically hidden in the dead angle region of the auxiliary microscope, macro observation using the auxiliary microscope can be performed without the field of vision being obstructed.

Next, when micro observation using the probe microscope is performed, when the probe microscope is made to approach the observation position on the subject of observation using the sixth microscope holding member, the distal end of the probe microscope is taken out of the dead angle region and appears within the field of vision of the auxiliary microscope. Therefore, by positioning the probe microscope while confirming the position of the distal end of the probe microscope using the field of vision of the auxiliary microscope, it is possible to set the optical axis position of the probe microscope.

In this way, according to the microscopic observing apparatus of the present invention, it is possible to set the optical axis position of the probe microscope while confirming the position of the distal end of the probe microscope using the field of vision of the auxiliary microscope. Accordingly, when switching from macro observation to micro observation using the probe microscope having a relatively high magnification optical system and the auxiliary microscope having a low magnification optical system, the probe microscope can be easily and accurately positioned at the desired observation position.

Moreover, during the micro observation using the probe microscope, because it is possible to withdraw the seventh microscope holding member together with the auxiliary microscope from the area above the subject of observation, it is possible to secure a large working space.

### BRIEF DESCRIPTION OF THE DRAWINGS

FIG. 1 is a view showing a first embodiment of the microscopic observing apparatus of the present invention, and shows the overall structure of the apparatus.

FIG. 2 is a view for explaining the structure of the probe microscope provided in the above microscopic observing apparatus.

FIG. 3 is a plan view showing a supporting mechanism of the above probe microscope.

FIG. 4 is a vertical cross-sectional view for explaining an optical system in the stereoscopic microscope provided in this microscopic observing apparatus.

FIG. 5 is a view showing a second embodiment of the microscopic observing apparatus of the present invention, and is a side view showing the vicinity of a portion of a stereoscopic microscope where an objective lens is installed.

FIGS. 6A and 6B are views showing this microscopic observing apparatus. FIG. 6A shows relative positions between the optical axes of the stereoscopic microscope and the probe microscope. FIG. 6B is a view showing another example of this microscopic observing apparatus, and shows a visual field when a video microscope is used instead of a stereoscopic microscope.

FIG. 7 is a view showing another example of this microscopic observing apparatus, and is a side view showing a case in which a hood that fixes observed subject by pressing it is mounted.

FIG. 8 is a view showing a third embodiment of the microscopic observing apparatus of the present invention, and is a side view showing the vicinity of a portion of a stereoscopic microscope where an objective lens is installed.

FIG. 9 is a plan view showing an arrangement of a probe relative to the optical axes of this stereoscopic microscope, and is a view looking from the direction of A-A shown in FIG. 8.

FIG. 10 is a view showing a fourth embodiment of the microscopic observing apparatus of the present invention, and is a vertical cross-sectional view for explaining a position of a probe relative to an optical system of a Greenough type of stereoscopic microscope.

FIGS. 11A and 111B are views showing an example of an inclining mechanism of this probe, and are both views looking from the direction of B-B shown in FIG. 10.

FIG. 12 is a frontal view showing a fifth embodiment of the microscopic observing apparatus of the present invention.

FIG. 13 is a view showing this microscopic observing apparatus, and is a vertical cross sectional view looking from the direction of A1-A1 shown in FIG. 12.

FIG. 14 is a view for explaining an internal structure of the stereoscopic microscope provided in this microscopic observing apparatus.

FIG. 15 is a view showing another example of this microscopic observing apparatus, and is a vertical cross sectional view corresponding to FIG. 13.

FIG. 16 is a frontal view showing a sixth embodiment of the microscopic observing apparatus of the present invention.

FIG. 17 is a view showing a portion of this microscopic observing apparatus, and is a plan view looking from the direction of B1-B1 shown in FIG. 16.

FIG. 18 is a plan view showing a seventh embodiment of the microscopic observing apparatus of the present invention.

FIG. 19 is a view showing this microscopic observing apparatus, and is a vertical cross-sectional view looking from the direction of C1-C1 shown in FIG. 18.

FIG. 20 is a plan view showing an eighth embodiment of the microscopic observing apparatus of the present invention.

FIG. 21 is a view showing this microscopic observing apparatus, and is a frontal view looking from the direction of D1-D1 shown in FIG. 20.

FIG. 22 is a view showing this microscopic observing apparatus, and is a vertical cross sectional view looking from the direction of E1-E1 shown in FIG. 21.

FIG. 23 is a frontal view showing a ninth embodiment of the microscopic observing apparatus of the present invention.

FIG. 24 is a frontal view showing a tenth embodiment of the microscopic observing apparatus of the present invention.

FIG. 25 is a frontal view showing an eleventh embodiment of the microscopic observing apparatus of the present invention.

FIG. 26 is a view showing another example of this microscopic observing apparatus, and is a view corresponding to a portion F1 shown in FIG. 25.

FIG. 27 is a plan view showing a twelfth embodiment of the microscopic observing apparatus of the present invention.

FIG. 28 is a view showing a portion of this microscopic observing apparatus, and is a side view looking from the direction of GI shown in FIG. 27.

### DETAILED DESCRIPTION OF THE INVENTION

Respective embodiments of the microscopic observing apparatus that is provided with the probe microscope of the present invention will now be described with reference to the drawings, however, it is to be understood that the present invention is not limited only to these embodiments.

(First Embodiment)

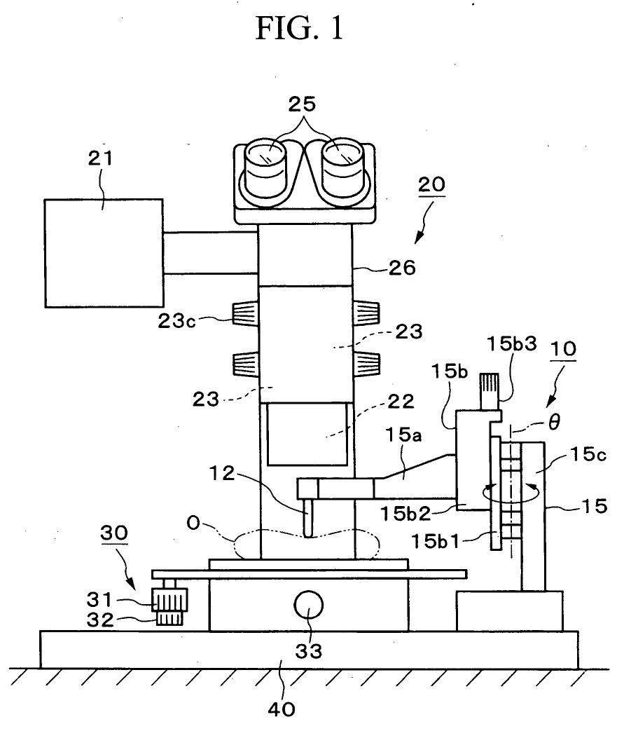

Firstly, the first embodiment of the present invention will be described below with reference to FIGS. 1 to 4.

As is shown in FIG. 1, the microscopic observing apparatus of the present invention is provided with: a probe microscope 10 having a relatively high magnification optical system; a stereoscopic microscope having a low magnification optical system; a specimen stage 30 on which is placed a subject of observation O such as an experimental animal; and a base 40 on which the probe microscope 10, the stereoscopic microscope 20, and the specimen stage 30 are installed.

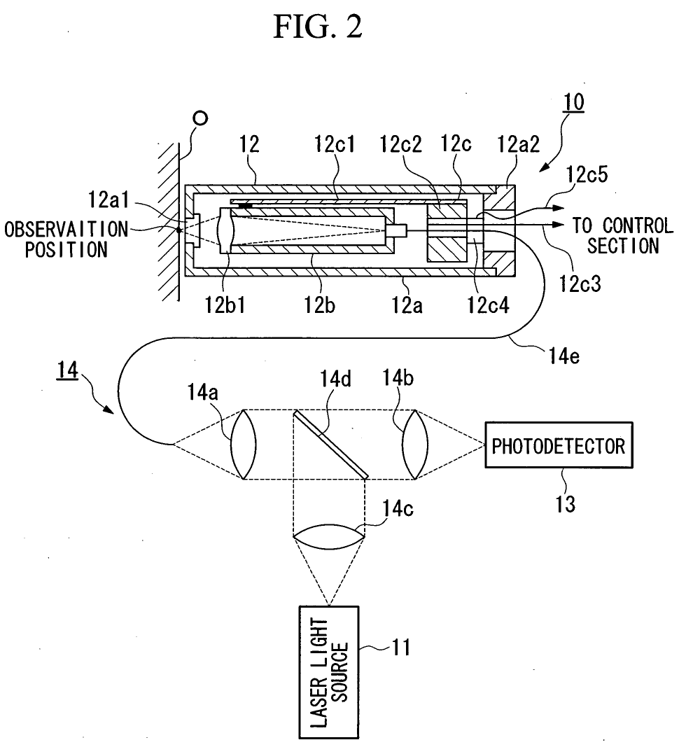

As is shown in FIG. 2, the probe microscope 10 is provided with: a laser light source 11 that generates laser light; a probe (i.e. probe body) 12 that is formed in a narrow, elongated shape such that it can be inserted in a body cavity or the like, and that emits laser light from the laser light source 11 from the distal end side of the probe 12 towards a specimen (i.e., the subject of observation O), and also acquires light from the specimen; a photodetector 13 that receives light from the probe 12 and performs photoelectric conversion thereon; a transmission optical system 14 that transmits laser light from the laser light source 11 to the probe 12 and also transmits light from the probe 12 to the photodetector 13; a control section (not shown) that controls the overall system including the conversion into an image of electrical signals from the photodetector 13 as well as control of the XY scan section 12c (described below) provided in the probe 12; a display unit (not shown) that projects images formed by the control section; and a probe supporting base (i.e., a first supporting member—see FIG. 1) 15 that supports the probe 12 on the base 40.

The laser light source 11 may be formed, for example, by an argon laser oscillation apparatus that outputs laser light having a wavelength of 488 nm as light suitable for cell observation.

The probe 12 is provided with an outer cylinder 12a that is formed as a hollow circular cylinder, an inner cylinder 12b that is supported in a floating state inside the outer cylinder 12a, an XY scan section 12c that supports the inner cylinder 12b and that scans in an X axial direction and a Y axial direction, and a convex lens 12b1 that condenses laser light emitted from a distal end of an optical fiber 14e (described below) onto an observation point, and also condenses light from the observation point onto the distal end.

The outer cylinder 12a is a hollow circular cylinder having an outer diametrical dimension of, for example, 2-5 mm in diameter. A cover glass 12a1 that faces the observation point is fixed to an aperture portion formed at a distal end side of the outer cylinder 12a. On the other hand, a base 12a2 is fixed to an aperture portion formed at the rear end side of the outer cylinder 12a so as to cover this aperture portion and also support the XY scan section 12c.

A convex lens (i.e., an objective lens of the probe microscope) 12b1 that faces the observation point via the opposing cover glass 12a1 is fixed to an aperture portion formed at a distal end side of the inner cylinder 12b. On the other hand, a distal end of the optical fiber 14e that is provided in the transmission optical system 14 is fixed to an aperture portion formed at the rear end side of the inner cylinder 12b so as to face the convex lens 12b1.

The XY scan section 12c is provided with a piezo actuator 12c1 that moves the inner cylinder 12b in the x axial direction (i.e., in an up/down direction in the drawing in FIG. 2) relatively to the outer cylinder 12a, a base 12c2 to which a base end portion of the piezo actuator 12c1 is fixed, a wire 12c3 that is connected to the piezo actuator 12c1, a piezo actuator 12c4 that moves the inner cylinder 12b in the y axial direction (i.e., in a vertical direction relative to the surface of the paper showing FIG. 2) relatively to the outer cylinder 12a, a base 12a2 to which a base end portion of the piezo actuator 12c4 is fixed, and a wire 12c5 that is connected to the piezo actuator 12c4.

Note that the wires 12c3 and 12c5 are guided to the outside from the base 12a2 and are connected to the control section.

According to this XY scan section 12c, when a voltage from the control section is applied to the piezo actuator 12c1 via the wire 12c3, the piezo actuator 12c1 is moved to bend in the x axial direction. As a result, the optical axis of the convex lens 12b1 (namely, the scan point) can be made to scan in the x axial direction. When a voltage from the control section is applied to the piezo actuator 12c4 via the wire 12c5, the piezo actuator 12c4 is moved to bend in the y axial direction. As a result, the optical axis of the convex lens 12b1 (namely, the scan point) can be made to scan in the y axial direction.

By receiving signal light at the photodetector 13 while causing the scan point to scan in the x axial direction and y axial direction in this manner, it is possible to obtain a field of vision of, for example, 40 μm×40 μm to 400 μm×400 μm.

The transmission optical system 14 is provided with lenses 14a, 14b, and 14c, a beam splitter 14d placed between these, and the optical fiber 14e that connects the lens 14a to the inner cylinder 12b.

According to this transmission optical system 14, laser light from the laser light source 11 is guided to the interior of the inner cylinder 12b through the lens 14b, the beam splitter 14d, the lens 14a, and the optical fiber 14e.

In addition, according to this transmission optical system 14, light that is guided to the interior of the inner cylinder 12b is guided to the interior of the photodetector 13 through the optical fiber 14e, the lens 14a, the beam splitter 14d, and the lens 14c.

The photodetector 13 photoelectrically converts light from the optical fiber 14e into electrical signals that correspond to the optical intensity thereof, and is internally provided with an amplifier that amplifies these electrical signals. Output signals from the photodetector 13 are converted into image signals in the control section and are then displayed on the display unit.

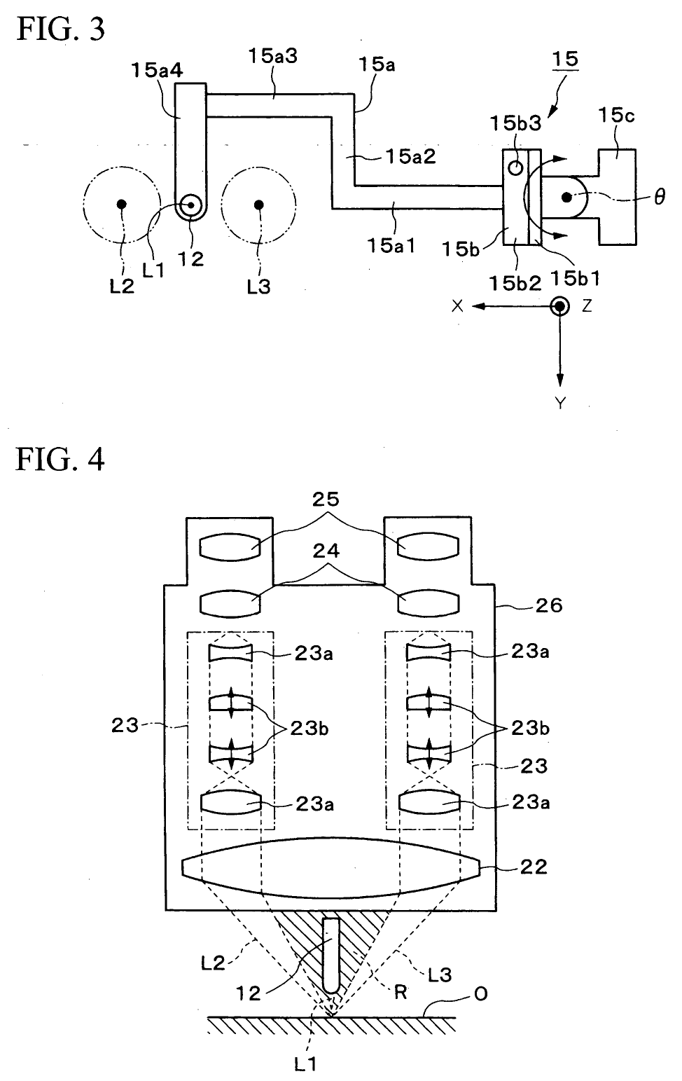

As is shown in FIGS. 1 and 3, the probe supporting base 15 is provided with a horizontal arm (i.e., the first supporting member) 15a that holds a distal end of the probe 12 such that it faces the stage 30 directly beneath it, a Z stage 15b that moves this horizontal arm 15a up and down in a Z direction (i.e., in an up/down direction in FIG. 1 and in a vertical direction relative to the surface of the paper in FIG. 3), and a θ stage 15c that rotatably supports the Z stage 15b such that it can rotate around the vertical axis θ.

The θ stage 15c is mounted on and fixed to the top of the base 40, and allows the Z stage 15b to rotate around the vertical axis θ only when a fixing screw (not shown) is loosened. When the fixing screw is tightened and fixed in place, because the rotation operation of the Z stage 15b is restricted, the horizontal arm 15a and the probe 12 can be fixed in position around the vertical axis θ.

According to this θ stage 15, when the subject of observation O is placed on the specimen stage 30, or when the subject of observation O is removed from the specimen stage 30, by loosening the fixing screw, the probe 12 and horizontal arm 15a can be swung around the vertical axis θ and withdrawn from above the specimen stage 30.

The Z stage 15b is provided with a rotating member 15b1 that is rotatably linked to the θ stage 15c side, a vertically moving member 15b2 that is connected such that it can move up and down relative to the rotating member 15b1, and an operating screw 15b3 that adjusts the vertical position of the vertically moving member 15b2.

According to this Z stage 15b, by turning the operating screw 15b3 the height in the Z axial direction of the probe 12 and the horizontal arm 15a can be adjusted.

When seen in the plan view shown in FIG. 3, the horizontal arm 15a is provided with a first arm portion 15a1 that extends from the Z stage 15b in a horizontal direction, a second arm portion 15a2 that forms a right angle relative to the first arm portion 15a1, a third arm portion 15a3 that forms a right angle relative to the second arm portion 15a2, and a fourth arm portion 15a4 that forms a right angle relative to the third arm portion 15a3 and that places the optical axis L1 of the probe 12 between the two optical axes L2 and L3 of the stereoscopic microscope 20. Note that the correlation between the optical axes L1, L2, and L3 is described below in detail with reference to FIG. 4. Of these arms, as is shown in FIG. 3, the second arm portion 15a2, the third arm portion 15a3, and the fourth arm portion 15a4 form a U shape that avoids one of the optical axes L3 of the stereoscopic microscope 20. As a result, the horizontal arm 15a is prevented from intruding into the field of vision of the stereoscopic microscope 20.

The stereoscopic microscope 20 is a Galileo type microscope and, as is shown in FIG. 1 and FIG. 4, is provided with a light source 21 that supplies illumination light, an illumination optical system (not shown) that guides light from the light source 21 onto the subject of observation O so as to illuminate the subject of observation O, an objective lens 22 that receives the irradiation of reflected light that is illumination light reflected by the subject of observation O, a zoom optical system 23 that transmits reflected light that has passed through the objective lens 22, a focusing lens 24, an ocular lens 25, and a casing 26 that houses these.

As is shown in FIG. 4, two sets of the zoom optical system 23, the focusing lens 24, and the ocular lens 25 are provided for the single objective lens 22.

Each of the zoom optical systems 23 is provided with a pair of fixed lenses 23a that are fixed in position at top and bottom ends of the zoom optical systems 23, and a moving lens 23b that is positioned between the fixed lenses 23a so as to be able to move up and down. The moving lenses 23b can be made to move up and down by turning the zoom operating knob 23c shown in FIG. 1, and the zoom magnification of the zoom optical systems 23 can be adjusted, for example, within a magnification range of approximately 1 to 10. Note that the field of vision of the stereoscopic microscope 20 may be, for example, a diameter of 2 mm to 20 mm, which is extremely broad compared to the field of vision of the probe microscope 10.

As is shown in FIG. 4, the optical axis L1 of the probe microscope 10 is placed between the optical axes L2 and L3 that are formed between the objective lens 22 of the stereoscopic microscope 20 and the subject of observation O. Namely, a dead angle region R (i.e., the area indicated by the hatching in FIG. 4) which forms a dead angle is formed between the optical axes L2 and L3, and the probe 12 is placed within this dead angle region R.

In fact, because the distal end of the probe 12 is extremely close to the subject of observation O (for example, at an operating distance of 0 to 500 μm), the probe 12 cannot be made to be completely within the dead angle region R, however, because the portion that protrudes so as to intrude into the field of vision of the stereoscopic microscope 20 is only the distal end portion which has a very narrow diameter, it is possible to restrict the intrusion of the probe 12 to minimum compared with when substantially the entire probe 12 intrudes within the field of vision of the stereoscopic microscope 20, as is the case conventionally.

As is shown in FIG. 1, the specimen stage 30 is formed by an X stage that moves the position where the subject of observation O has been placed in the X axial direction (i.e., to the left and right in the drawing in FIG. 1), a Y stage that moves the position in the Y axial direction (i.e., vertically upwards from the surface of the paper shown in FIG. 1), and a Z stage that moves the position in the Z direction (i.e., up and down direction in FIG. 1). The X stage is operated by the adjustment knob 31, the Y stage is operated by the adjustment knob 32, and the Z stage is operated by the adjustment knob 33.

According to this specimen stage 30, after the subject of observation O has been placed on the base, positioning is performed in order to view the desired observation point by operating the adjustment knobs 31, 32, and 33 while viewing via the stereoscopic microscope 20. Thereafter, observation using the probe microscope 10 is performed by matching the optical axis L1 of the probe 12 to the observation point. In this way, it is possible to transit smoothly from low magnification observation that employs the stereoscopic microscope 20 to high magnification observation that employs the probe microscope 10.

The microscopic observing apparatus of the present embodiment that is described above employs a structure in which the optical axis L1 of the probe microscope 10 is placed between the optical axes L2 and L3 of the stereoscopic microscope 20. By employing this structure, substantially the entire probe 12 of the probe microscope 10 is placed within the dead angle region R of the stereoscopic microscope 20. As a result, it is possible to restrict the obstruction of the field of vision of the stereoscopic microscope 20 to minimum and to secure an excellent field of vision.

Moreover, the microscopic observing apparatus of the present embodiment employs a structure in which the probe 12 is supported by the horizontal arm 15a which avoids the optical axes L2 and L3. By employing this structure, it is possible to prevent the horizontal arm 15a from intruding into the field of vision of the stereoscopic microscope 20, thereby enabling the field of vision of the stereoscopic microscope 20 to be improved.

Note that in the present embodiment, the optical axis L1 of the probe 12 is kept at a constantly perpendicular attitude relative to the top surface of the specimen stage 30, however, the present embodiment is not limited to this and it is also possible to employ a structure in which the probe 12 can be inclined in accordance with the observation location. As the direction of the inclination in this case, it is preferable that the probe be inclined relative to a perpendicular direction of the surface of the paper showing FIG. 4 in order to prevent the probe 12 from intruding into the field of vision of the stereoscopic microscope 20.

Furthermore, in the present embodiment, a structure is employed in which the probe 12 is supported by the horizontal arm 15a, however, the present embodiment is not limited to this and it is also possible to employ a structure in which the probe 12 is supported by a supporting member formed from a transparent material such as a glass plate. In this case too, even if the supporting member intrudes into the field of vision of the stereoscopic microscope, because the supporting member is transparent, the field of vision is not obstructed and an excellent field of vision can be obtained for the stereoscopic microscope 20.

Moreover, in the present embodiment, the probe microscope 10 receives reflected light from the subject of observation O to observe this subject of observation, however, the present embodiment is not limited to this and by replacing the beam splitter 14d with a dichroic mirror, fluorescence generated by the subject of observation O can be observed.

(Second Embodiment)

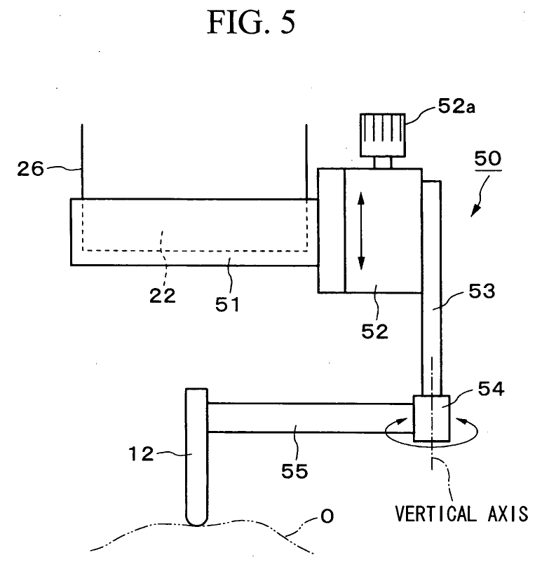

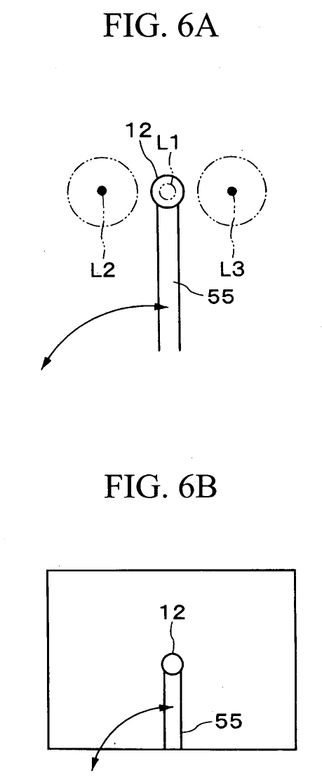

Next, the second embodiment of the microscopic observing apparatus of the present invention will be described referring to FIGS. 5, 6A and 6B. Moreover, the point that are different from the above described first embodiment will be explained below, while the remainder of the structure can be taken as being the same as that of the above first embodiment and a description thereof is omitted.

FIG. 5 is a view showing a portion of the microscopic observing apparatus of the present embodiment, and is a side view showing a vicinity of a portion of the stereoscopic microscope 20 where the objective lens 22 is installed. FIG. 6A shows the optical axes of this microscopic observing apparatus. FIG. 6B is a view showing another example of this microscopic observing apparatus, and shows a visual field when a video microscope is used instead of the stereoscopic microscope 20.

As is shown in FIG. 5, a feature of the microscopic observing apparatus of the present embodiment is that, instead of using the probe supporting base 15 that supports the base 40 as the supporting mechanism of the probe 12, the microscopic observing apparatus of the present embodiment is provided with a probe support base 50 that supports the casing 26 of the stereoscopic microscope 20.

As is shown in FIG. 5, the probe support base 50 is provided with an adapter 51 that is fixed to a position on the casing 26 in the vicinity of where the objective lens 22 is installed, a Z stage 52 that moves up and down relative to the adapter 51, a rod 53 that is fixed so as to hang vertically down relative to the stage 52, and a horizontal arm 55 that is linked to a bottom end of the rod 53 via a bearing 54 and that holds the probe 12.

The height position of the Z stage 52 can be minutely adjusted by rotating an operating knob 52a provided on the Z stage. Accordingly, by rotating the operating knob 52a, the probe 12 can be moved closer to or further away from the subject of observation O.

The horizontal arm 55 rotates around a vertical axis relative to the rod 53 only when a fixing screw (not shown) is loosened. When the fixing screw is tightened and fixed in place, because the rotation operation of the horizontal arm 55 is restricted, the position of the probe 12 can be fixed around the vertical axis. When the horizontal arm 55 is rotated so that the probe 12 is moved to the position for making an observation, then, as is shown in FIG. 6A, the horizontal arm 55 is restricted such that the optical axis L1 stops at a central position between the optical axes L2 and the L3.

According to this probe support base 50, when the subject of observation O is placed on the specimen stage 30, or when the subject of observation O is removed from the specimen stage 30, by firstly operating the operating knob 52a so that the probe 12 is withdrawn upwards and then loosening the fixing screw, the probe 12 can be swung around the vertical axis and withdrawn from above the specimen stage 30. As a result, the placement or removal of the subject of observation O can be easily performed.

Moreover, according to the probe support base 50 of the present embodiment, as was described for the first embodiment, because the probe 12 is positioned within the dead angle area formed between the optical axes L2 and L3, it is possible to restrict the obstruction of the field of vision of the stereoscopic microscope 20 by the probe 12 to minimum and to secure an excellent field of vision.

In addition, the microscopic observing apparatus of the present embodiment employs a structure in which the probe 12 is supported by the horizontal arm 55 which avoids the optical axes L2 and L3. By employing this structure, it is possible to prevent the horizontal arm 55 from intruding into the field of vision of the stereoscopic microscope 20, thereby enabling the field of vision of the stereoscopic microscope 20 to be improved.

Furthermore, according to the microscopic observing apparatus of the present embodiment, when the stereoscopic microscope 20 side is moved closer to or further away from the observation surface, because the probe support base 50 also moves closer to or further away therefrom integrally with the stereo microscope 20, if the focal plane of the probe 12 is matched in advance using the Z stage 52 to the focal plane of the stereoscopic microscope 20, then by matching the focal plane of the stereoscopic microscope 20 to the observation plane the focal plane of the probe 12 is automatically matched to the observation plane. Accordingly, the operation to focus the probe 12 is extremely simple.

Note that, in the above described first and second embodiments, cases are described in which the low magnification microscope that is combined with the probe microscope 10 of the present invention is the stereoscopic microscope 20, however, it is also possible to employ a video microscope instead. In this case, as is shown in FIG. 6B, the optical axis of the probe 12 is held so as to substantially match the optical axis of the video microscope. Accordingly, the field of vision of the video microscope becomes a field of vision such as that shown in FIG. 6B, and the probe 12 appears in the center. However, as is shown in FIG. 6B, the size of the probe 12 within the field of vision of the video microscope can be kept to a minimum.

In this case, the horizontal arm 55 (or the horizontal arm 15a) also intrudes into the field of vision, however, by reducing the thickness dimension (when seen in plan view) to a minimum, or by supporting the probe 12 using a transparent member such as a glass plate, the appearance of the supporting member can be reduced to a minimum or reduced to nothing.

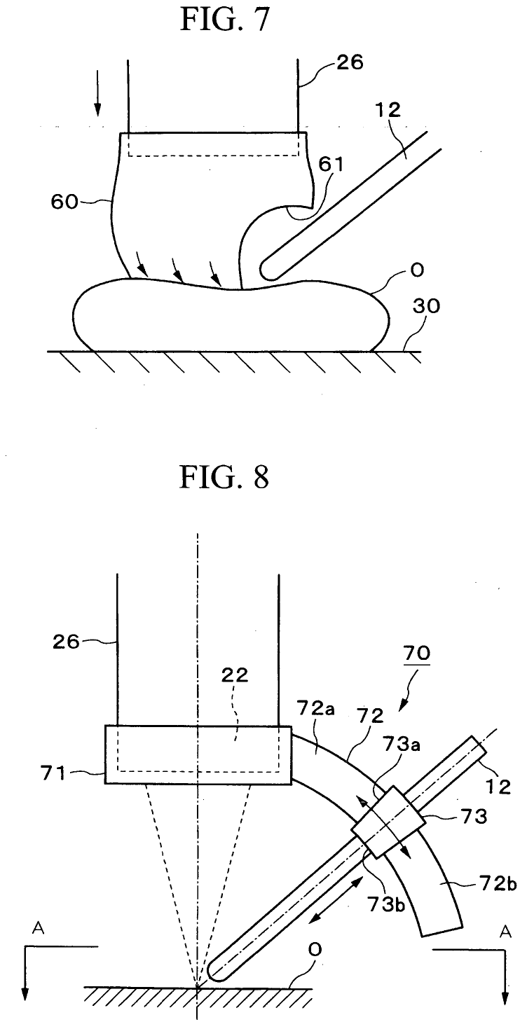

Note that, in the above described first and second embodiments, as a device for further simplifying observations using the probe microscope 10, as is shown in FIG. 7, it is possible to provide a hood 60 formed from a material having flexibility such as a rubber material in the stereoscopic microscope 20. This hood 60 is mounted at a position on the casing 26 where the objective lens 22 is provided, and by making the casing 26 move closer to the stage 30, the subject of observation O can be sandwiched and fixed between these two. As a result, even if the subject of observation O attempts to move, this movement can be inhibited by the hood 60 so that the observation point can be prevented from moving out of the field of vision.

Moreover, an aperture portion 61 is formed in a side wall of the hood 60, and it is possible to insert the probe 12 on an inclination into the hood 60 through this aperture portion 61.

(Third Embodiment)

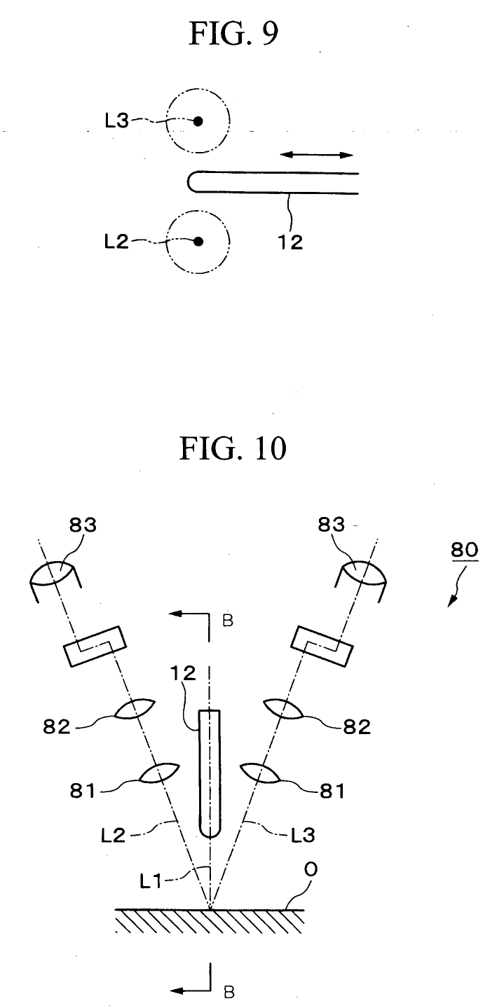

Next, the third embodiment of the microscopic observing apparatus of the present invention will be described referring to FIGS. 8 and 9. Moreover, the point that are different from the above described first embodiment will be explained below, while the remainder of the structure can be taken as being the same as that of the above first embodiment and a description thereof is omitted.

FIG. 8 is a view showing a portion of the microscopic observing apparatus of the present embodiment, and is a side view showing a portion of the stereoscopic microscope 20 where the objective lens 20 is installed. FIG. 9 is a plan view showing relative positions of the probe 12 and the optical axes of this microscopic observing apparatus.

As is shown in FIG. 8, a feature of the microscopic observing apparatus of the present embodiment is that, instead of using the probe supporting base 15 that supports the base 40 as the supporting mechanism of the probe 12, the microscopic observing apparatus of the present embodiment is provided with a probe support base 70 that supports the casing 26 of the stereoscopic microscope 20.

This probe support base 70 is provided with an adaptor 71 that is fixed to a position on the casing 26 in the vicinity of where the objective lens 22 is installed, an arc-shaped slide guide 72 that is fixed to the adapter 71, and a probe holding section 73 that is mounted on the slide guide 72 and holds the probe 12.

A base end portion 72a of the slide guide 72 is fixed at a central position between the optical axes L2 and L3 when the casing 26 is seen in frontal view. An arc-shaped guide portion 72b is formed extending obliquely downwards from the base end portion 72a. The arc-shaped configuration of the guide portion 72b has a radius of curvature that centers on the focal position of the probe 12.

The probe holding portion 73 is provided with a gripping portion 73a, which is a penetrating portion that grips the slide guide 72, and a probe insertion hole 73b, which is a through hole into which the probe 12 is inserted. The gripping portion 73a is provided with an adjustment knob (not shown), and by operating this adjustment knob, the gripping portion 73a can be moved along the arc-shaped configuration of the slide guide 72 and precise adjustments can be made to the position thereof. Moreover, a fixing screw (not shown) is provided in the gripping portion 73a, and if this is tightened, movement of the gripping portion 73a is permitted, while if it is loosened, the gripping portion 73a can be fixed such that it cannot move relatively to the slide guide 72.

The probe insertion hole 73b is a through hole formed with an orientation that causes the optical axis of the probe 12 to always face the observation point, and is provided with a fixing screw (not shown). When this fixing screw is loosened, as is shown in FIG. 9, the probe 12 can be moved up and down along its axis (i.e., optical axis). When the fixing screw is tightened, the probe 12 can be fixed so that it cannot move relative to the probe holding member 73. Note that the symbols L2 and L3 in FIG. 9 show the optical axes L2 and L3.

According to this probe support base 70, when the subject of observation O is placed on the specimen stage 30, or when the subject of observation O is removed from the specimen stage 30, the probe 12 is withdrawn upwards. As a result, the placement or removal of the subject of observation O can be easily performed.

In addition, if the need arises to adjust the inclination angle of the probe 12 in accordance with the observation point, the fixing screw on the gripping portion 73a side is firstly loosened and then the operating knob is operated.

Moreover, according to the probe support base 70 of the present embodiment, because the probe 12 is positioned within the dead angle region formed between the optical axes L2 and L3, it is possible to restrict the obstruction of the field of vision of the stereoscopic microscope 20 by the probe 12 to minimum and to secure an excellent field of vision.

In addition, the microscopic observing apparatus of the present embodiment employs a structure in which the probe 12 is supported by the slide guide 72 and the probe holding portion 73 which avoid the optical axes L2 and L3. By employing this structure, it is possible to prevent the slide guide 72 and the probe holding portion 73 from intruding into the field of vision of the stereoscopic microscope 20, thereby enabling the field of vision of the stereoscopic microscope 20 to be improved.

Furthermore, according to the microscopic observing apparatus of the present embodiment, when the stereoscopic microscope 20 is moved closer to or further away from the observation surface, because the probe support base 70 also moves closer to or further away therefrom integrally with the stereo microscope 20, if the focal plane of the probe 12 is matched in advance to the focal plane of the stereoscopic microscope 20, then by matching the focal plane of the stereoscopic microscope 20 to the observation plane the focal plane of the probe 12 is also automatically matched to the observation plane. Accordingly, the operation to focus the probe 12 is extremely simple.

(Fourth Embodiment)

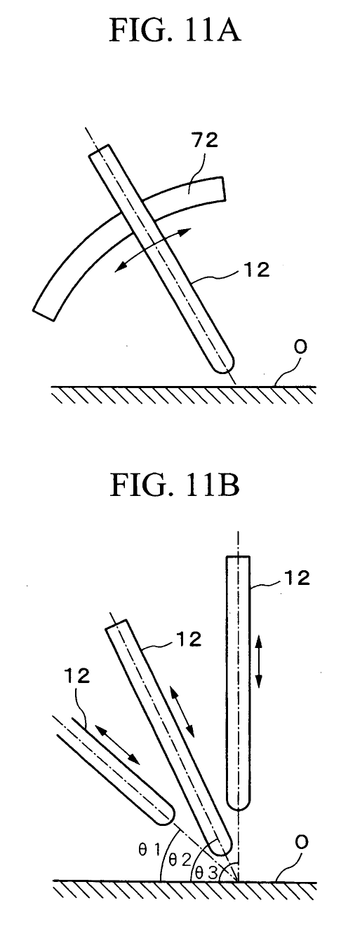

Next, the fourth embodiment of the microscopic observing apparatus of the present invention will be described referring to FIGS. 10, 11A and 11B. Moreover, the point that are different from the above described first embodiment will be explained below, while the remainder of the structure can be taken as being the same as that of the above first embodiment and a description thereof is omitted.

FIG. 10 is an explanatory view showing a positional relationship between an optical system of a Greenough type of stereoscopic microscope that is provided in the microscopic observing apparatus of the present embodiment and the probe 12. FIGS. 11A and 11B are views showing another example of the present embodiment, and are views looking from the direction of B-B in FIG. 10.

As is shown in FIG. 10, features of the microscopic observing apparatus of the present embodiment are that it employs a Greenough type of stereoscopic microscope 80 instead of the Galileo type of stereoscopic microscope 20, and that the probe 12 is installed inside the casing.

This Greenough type of stereoscopic microscope 80 is provided with a light source (not shown) that supplies illumination light, an illumination optical system (not shown) that guides light from the light source onto the subject of observation O so as to illuminate the subject of observation O, an objective lens 81 that receives the irradiation of reflected light that is reflected by the subject of observation O, a zoom optical system 82 that transmits reflected light that has passed through the objective lens 81, a focusing lens 24, an ocular lens 83, and a casing (not shown) that houses these.

As is shown in FIG. 10, two sets of the objective lens 81, the zoom optical system 82, and the ocular lens 83 are provided.

Moreover, because the microscopic observing apparatus of the present embodiment is a Greenough type, the objective lens 22 that is positioned in the center in the transverse direction of the casing 26, such as is shown in FIG. 4, is not provided. Accordingly, as is shown in FIG. 10, it is possible to position the probe 12 so that it passes through the center of an optical system for both left and right eyes. Namely, it is possible to house and hold the probe 12 such that it is able to move up and down inside the casing.

In addition, the optical axis L1 of the probe 12 of the probe microscope 10 is placed between the optical axes L2 and L3 that are formed between the respective objective lenses 81 of the stereoscopic microscope 80 and the subject of observation O. Namely, a dead angle region, which forms a dead angle, is formed between the optical axes L2 and L3, and the probe 12 is placed within this dead angle region.

In the microscopic observing apparatus of the present embodiment as well, it is possible to obtain the same effects as in the above described first embodiment. Namely, because substantially the entire probe 12 of the probe microscope 10 is positioned within the dead angle region of the stereoscopic microscope 80, it is possible to restrict the obstruction of the field of vision of the stereoscopic microscope 20 to minimum and to secure an excellent field of vision.

Moreover, because it is possible to also house the supporting mechanism that supports the probe 12 within the casing, it is possible to prevent this support mechanism from obstructing the field of vision of the stereoscopic microscope 80 and to secure an excellent field of vision.

Note that, if an adjustment to the inclination angle of the probe 12 is required, then it is possible to employ, for example, the structure shown in FIGS. 11A and 1I B.

Namely, FIG. 11A shows a case in which a guide support structure the same as that of the probe support base 70 is housed in the casing, so that the probe 12 is able to be tilted along the arc shaped configuration of the slide guide 72.

Moreover, in FIG. 1I B, one probe 12 is provided for each of the inclination angles θ1, θ2, and θ3, and the probe 12 that is positioned at the required inclination angle can be selected and located at the observation position thereof. Namely, the probes 12 are each positioned in a radial line configuration centered on the measurement point, and are able to be advanced or withdrawn in the axial direction thereof.

Accordingly, the one of the probes 12 that is selected for measuring (for example, the probe having the inclination angle θ2 shown in FIG. 11B.) is extended to its observation position, while the remainders of the probes 12 are withdrawn into the casing so as not to obstruct the observation.

(Fifth Embodiment)

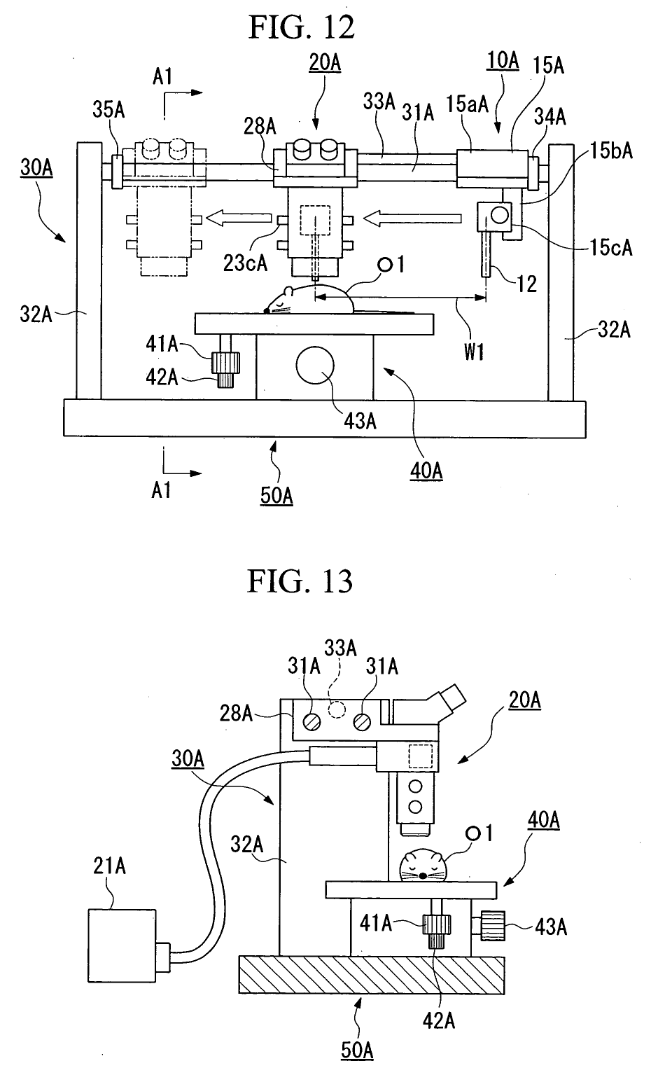

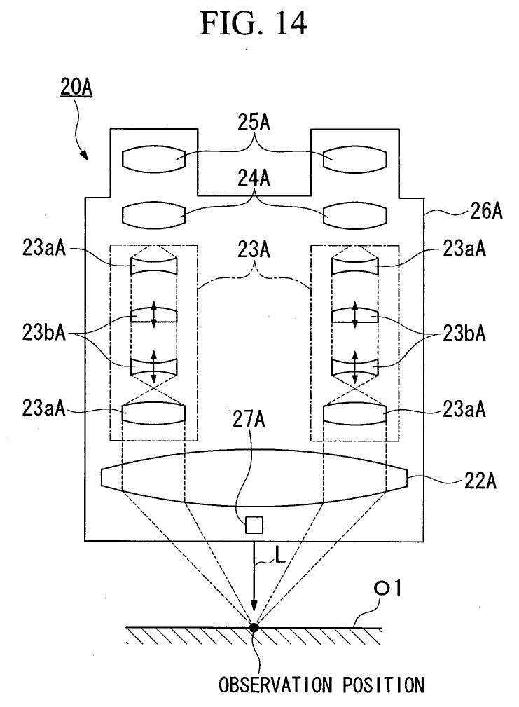

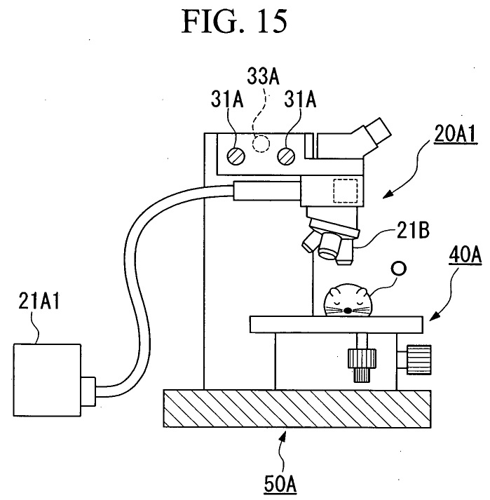

The fifth embodiment of the present invention will be described below referring to FIGS. 12 to 15. FIG. 12 is a frontal view showing the microscopic observing apparatus of the present embodiment. FIG. 13 is a view showing this microscopic observing apparatus, and is a vertical cross sectional view looking from the direction of A1-A1 in FIG. 12. FIG. 14 is an explanatory view for describing an internal structure of the stereoscopic microscope provided in this microscopic observing apparatus. FIG. 15 is a view showing another example of this microscopic observing apparatus, and is a vertical cross sectional view corresponding to FIG. 13.

As is shown in FIG. 12 and FIG. 13, the microscopic observing apparatus of the present embodiment is provided with a probe microscope 10A that has a relatively high magnification optical system, a stereoscopic microscope (i.e., an auxiliary microscope) 20A that has a low magnification optical system, a guide mechanism 30 that movably supports the probe microscope 10A and the stereoscopic microscope 20A, a specimen stage 40A on which is placed a subject of observation O1 such as an experimental animal that is to be observed using the probe microscope 10A and the stereoscopic microscope 20A, and that allows the absolute position of the subject of observation O1 to be adjusted, and a base 50A on which the specimen stage 40A and the guide mechanism 30A are installed.

The stereoscopic microscope 20A is a Galileo type of microscope and, as is shown in FIG. 13 and FIG. 14, is provided with a light source 21A that supplies illumination light to the subject of observation O1, an objective lens 22A that receives the irradiation of reflected light that is illumination light reflected by the subject of observation O1, a zoom optical system 23A that transmits reflected light that has passed through the objective lens 22A, a focusing lens 24A, an ocular lens 25A, a casing 26A that houses these, and a stereoscopic microscope support base (see FIG. 12 and FIG. 13) 28A that supports the casing 26A such that it can move along the guide mechanism 30A.

As is shown in FIG. 13, the stereoscopic microscope support base 28A is supported such that it can travel along a pair of guide rails 31A belonging to the guide mechanism 30A. In addition, the stereoscopic microscope 20A is held by the stereoscopic microscope support base 28A such that the optical axis thereof faces in a vertical direction.

As is shown in FIG. 14, two sets of the zoom optical system 23A, the focusing lens 24A, and the ocular lens 25A are provided for the single objective lens 22A.

Each of the zoom optical systems 23A is provided with a pair of fixed lenses 23aA that are fixed in position at top and bottom ends of the zoom optical systems 23A, and a moving lens 23bA that is positioned between the fixed lenses 23aA so as to be able to move up and down. The respective moving lenses 23bA can be made to move up and down by turning the zoom operating knob 23cA shown in FIG. 12, and the zoom magnification of the zoom optical systems 23A can be adjusted, for example, within a magnification range of approximately 1 to 10. Note that the field of vision of the stereoscopic microscope 20A may be, for example, a diameter of 2 mm to 20 mm, which is extremely broad compared to the field of vision of the probe microscope 10A (for example, 40 μm×40 μm to 400 μm×400 μm). Cross hairs are also provided in the field of vision of the stereoscopic microscope 20A, and the optical axis position within the field of vision can be confirmed as being the intersection point of the cross hairs.

Moreover, as is shown in FIG. 14, the stereoscopic microscope 20A is further provided with a laser pointer light source (i.e., a first laser light irradiation device) 27A that irradiates laser light L towards an observation position where the optical axis of the stereoscopic microscope 20 strikes the subject of observation O1.

According to this laser pointer light source 27A, by confirming the position on the subject of observation O1 where emitted laser light is irradiated using the naked eye or the field of vision of the stereoscopic microscope 20A, it is possible to visually confirm the position of the optical axis of the stereoscopic microscope 20A relative to the subject of observation O1. Accordingly, the operation to position the optical axis of the stereoscopic microscope 20A during macro observation can be performed more easily and in a shorter time.

Note that when the subject of observation O1 is a fluorescent sample, it is possible to use an excitation wavelength for the wavelength of the laser light L. In this case, by irradiating laser light L onto the observation position of the subject of observation O1, it is possible to perform positioning using fluorescent observation in addition to normal observation.

The probe microscope 10A has the same component elements as the probe microscope 10 described in the first embodiment. Namely, as was described for FIG. 2, the probe microscope 10A is provided with: a laser light source 11 that generates laser light; a probe (i.e. probe body) 12 that is formed in a narrow, elongated shape such that it can be inserted in a body cavity or the like, and that emits laser light from the laser light source 11 from the distal end side of the probe 12 towards the subject of observation O1, and also acquires light from the subject of observation; a photodetector 13 that receives light from the probe 12 and performs photoelectric conversion thereon; a transmission optical system 14 that transmits laser light from the laser light source 11 to the probe 12 and also transmits light from the probe 12 to the photodetector 13; a control section (not shown) that controls the overall system including the conversion into an image of electrical signals from the photodetector 13 as well as control of the XY scan section 12c (described below) provided in the probe 12; a display unit (not shown) that displays images formed by the control section; and a probe supporting base (see FIG. 12) 15A that supports the probe 12 such that it can move along the guide mechanism 30A.

The laser light source 11 may be formed, for example, by an argon laser oscillation apparatus that outputs laser light having a wavelength of 488 nm as light suitable for cell observation.

The probe 12 is provided with an outer cylinder 12a that is formed as a hollow circular cylinder, an inner cylinder 12b that is supported in a floating state inside the outer cylinder 12a, an XY scan section 12c that supports the inner cylinder 12b and that scans in an X axial direction and a Y axial direction, and a convex lens 12b1 that condenses laser light emitted from a distal end of an optical fiber 14e (described below) onto an observation position, and also condenses light from the observation position onto the distal end.

The outer cylinder 12a is a hollow circular cylinder having an outer diametrical dimension of, for example, 2-5 mm in diameter. A cover glass 12a1 that faces the observation position is fixed to an aperture portion formed at a distal end side of the outer cylinder 12a. On the other hand, a base 12a2 is fixed to an aperture portion formed at the rear end side of the outer cylinder 12a so as to cover this aperture portion and also support the XY scan section 12c.

A convex lens (i.e., an objective lens of the probe microscope) 12b1 that faces the observation position via the opposing cover glass 12a1 is fixed to an aperture portion formed at a distal end side of the inner cylinder 12b. In contrast, a distal end of the optical fiber 14e that is provided in the transmission optical system 14 is fixed to an aperture portion formed at the rear end side of the inner cylinder 12b so as to face the convex lens 12b1.

The XY scan section 12c is provided with a piezo actuator 12c1 that moves the inner cylinder 12b in the x axial direction (i.e., in an up/down direction in the drawing) relatively to the outer cylinder 12a, a base 12c2 to which a base end portion of the piezo actuator 12c1 is fixed, a wire 12c3 that is connected to the piezo actuator 12c1, a piezo actuator 12c4 that moves the inner cylinder 12b in the y axial direction (i.e., in a vertical direction relative to the surface of the paper showing the drawing) relatively to the outer cylinder 12a, a base 12a2 to which a base end portion of the piezo actuator 12c4 is fixed, and a wire 12c5 that is connected to the piezo actuator 12c4.

Note that the wires 12c3 and 12c5 are guided to the outside from the base 12a2 and are connected to the control section.

According to this XY scan section 12c, when a voltage from the control section is applied to the piezo actuator 12c 1 via the wire 12c3, the piezo actuator 12c1 is moved to bend in the x axial direction. As a result, the optical axis of the convex lens 12b1 (namely, the scan point) can be made to scan in the x axial direction. When a voltage from the control section is applied to the piezo actuator 12c4 via the wire 12c5, the piezo actuator 12c4 is moved to bend in the y axial direction. As a result, the optical axis of the convex lens 12b 1 (namely, the scan point) can be made to scan in the y axial direction. By receiving signal light in the photodetector 13 while causing the scan point to scan in the x axial direction and y axial direction in this manner, it is possible to obtain a field of vision of, for example, 40 μm×40 μm to 400 μm×400 μm.

The transmission optical system 14 is provided with lenses 14a, 14b, and 14c, a beam splitter 14d placed between these, and the optical fiber 14e that connects the lens 14a to the inner cylinder 12b.

According to this transmission optical system 14, laser light from the laser light source 11 is guided to the interior of the inner cylinder 12b through the lens 14b, the beam splitter 14d, the lens 14a, and the optical fiber 14e.

In addition, according to this transmission optical system 14, light that is guided to the interior of the inner cylinder 12b is guided to the interior of the photodetector 13 through the optical fiber 14e, the lens 14a, the beam splitter 14d, and the lens 14c.

The photodetector 13 photoelectrically converts light from the optical fiber 14e into electrical signals that correspond to the optical intensity thereof, and is internally provided with an amplifier that amplifies these electrical signals. Output signals from the photodetector 13 are converted into image signals in the control section and are then displayed on the display unit.

As is shown in FIG. 12, the probe support base 15A is provided with a traveling base 15aA that is supported so as to be able to travel along a pair of guide rails 31A (described below) belonging to the guide mechanism 30A, a Z stage 15bA that is supported so as to hang down from a bottom end of the traveling base 15aA, and a θ stage 15cA that is held by the Z stage 15bA. The probe 12 is held by the θ stage 15cA such that the optical axis thereof faces in a vertical direction.

By operating the Z stage 15bA the position of the probe 12 together with the θ stage 15cA is moved up and down in a vertical direction. Moreover, by operating the θ stage 15cA, the probe 12 is inclined in a θx direction and a θy direction (i.e., to the left and right in FIG. 12, and perpendicular to the surface of the paper showing FIG. 12).

As is shown in FIG. 12 and FIG. 13, the guide mechanism 30A is provided with a pair of column members 32A that stand upright at the left and right ends of the base 50A, the pair of guide rails (i.e., the first guide) 31A that extend between the respective top ends of the column members 32A, a connecting member 33A that connects the traveling base 15aA with the stereoscopic microscope support base 28A, a right stopper (i.e., a first restricting member) 34A that restricts further movement of the stereoscopic microscope 20A when the optical axis position of the stereoscopic microscope 20a matches a predetermined position (i.e., a central position in the longitudinal direction) on the guide rails 31A, and a left stopper (i.e., a second restricting member) 35A that restricts further movement of the probe microscope 10A when the optical axis position of the probe microscope 10A matches the predetermined position.

Each of the guide rails 31A penetrates a through hole formed respectively in the traveling base 15aA and the stereoscopic microscope support base 28A, and has the function of guiding the probe microscope 10A and the stereo microscope 20A such that they can move in one direction (i.e., in the left and right direction in FIG. 12) above the specimen stage 40A.

The connecting member 33A has the role of maintaining a constant spacing W1 between the optical axes of the probe microscope 10A and the stereoscopic microscope 20A. A locking screw (not shown) is provided in the connecting member 33A and, once the probe microscope 10A and the stereoscopic microscope 20A have been moved into position, by operating the locking screw so as to fix the connecting member 33A relative to the respective guide rails 31A, it is possible to reliably fix the relative positions of the probe microscope 10A and the stereoscopic microscope 20A relative to the subject of observation O1 on the specimen stage 40A.

As is shown in FIG. 12, the specimen stage 40A is formed by an X stage that moves the position of the subject of observation O1 placed thereon in an X axial direction (i.e., in the left and right directions in FIG. 12), a Y stage that moves the subject of observation O1 placed thereon in the Y axial direction (i.e., in a direction perpendicular to the surface of the paper showing FIG. 12), and a Z stage that moves the subject of observation O1 placed thereon in the Z direction (i.e., in the up and down directions in FIG. 12). The X stage is operated by the adjustment knob 41A, the Y stage is operated by the adjustment knob 42A, and the Z stage is operated by the adjustment knob 43A. The specimen stage 40A is placed in a central position directly beneath the respective guide rails 31A.

According to this specimen stage 40A, after a subject of observation O1 has been placed thereon, by then operating the adjustment knobs 41A, 42A, and 43A while viewing the subject of observation O1 through the stereoscopic microscope 20A, it is possible to match positions in order to view the desired observation position.

An observation method for observing the subject of observation O1 using the microscopic observing apparatus of the present embodiment having the above described structure will now be described.

Firstly, the subject of observation O1 is fixed in place on the specimen stage 40A. Next, the stereoscopic microscope 20A is moved towards the right in FIG. 12 along the respective guide rails 31A so as to approach a position directly above the subject of observation O1 on the specimen stage 40A. When the optical axis position of the stereoscopic microscope 20A reaches the predetermined position (i.e., a central position of the respective guide rails 31A), because the traveling base 15aA, which is integrally connected with the stereoscopic microscope 20A via the connecting member 33A, comes up against the right stopper 34A, further movement to the right is restricted and the stereoscopic microscope 20A stops.

In this stopped state, the locking screw is operated so that the position of the stereoscopic microscope 20A is fixed. Macro observation using the stereoscopic microscope 20A is then performed and, if necessary, the adjustment knobs 41A, 42A, and 43A are operated thereby adjusting the absolute position of the subject of observation O1 such that the desired observation visual field is obtained. During this positioning operation, laser light from the laser pointer light source 27A is irradiated onto the subject of observation O1, and by confirming the illumination position on the subject of observation O1 either by the naked eye or using the visual field of the stereoscopic microscope 20A, it is possible to visually confirm the position of the optical axis of the stereoscopic microscope 20A relative to the subject of observation O1. As a result of this operation, the relative positions between the specimen stage 40A and subject of observation O1 and the optical axis position of the stereoscopic microscope 20A at the moment the desired observation visual field is obtained are accurately set.

Note that when the subject of observation O1 is a fluorescent sample, then by using an excitation wavelength for the wavelength of the laser light L, it is possible to perform positioning using fluorescent observation in addition to normal observation.

Next, after the fixing in position of the stereoscopic microscope 20A using the locking screw has been released, this time the probe microscope 10A is moved to the left in FIG. 12 along the respective guide rails 31A so as to approach the position of the subject of observation O1. At this time, because the stereoscopic microscope 20A is connected to the probe microscope 10A via the connecting member 33A, the stereoscopic microscope 20A is automatically withdrawn from above the specimen stage 40A.

On the other hand, when the optical axis position of the probe microscope 10A reaches the predetermined position (i.e., the central position of the respective guide rails 31A), because the stereoscopic microscope support base 28A, which is integrally connected with the probe microscope 10A via the connecting member 33A, comes up against the right stopper 34A, further movement to the left is restricted and the probe microscope 10A stops.

In this stopped state, the locking screw is operated so that the position of the probe microscope 10A is fixed. As a result, the optical axis position when micro observation is performed using the probe microscope 10A can be automatically matched to the optical axis position when micro observation is performed using the auxiliary microscope (namely, to the predetermined position). Micro observation using the probe microscope 10A is then performed.

Note that when the subject of observation O1 is a fluorescent sample, then by making the wavelength of the laser light emitted from the laser light source 11 an excitation wavelength, it is possible to perform positioning using fluorescent observation in addition to normal observation.

According to the above described microscopic observing apparatus of the present embodiment, simply by moving the stereoscopic microscope 20A and the probe microscope 10A along the respective guide rails 31A, and by then stopping each in accordance with the right stopper 34A and the left stopper 35A, it is possible to automatically match the optical axis position when performing micro observation using the probe microscope 10A with the optical axis position when performing macro observation using the stereoscopic microscope 20A.

Accordingly, when switching from macro observation to micro observation using a probe microscope 10A having a relatively high magnification optical system and a probe microscope having a low magnification optical system, the probe microscope 10A can be easily and accurately positioned at the desired observation position.

Note that, in the present embodiment, a stereoscopic microscope 20A is employed as the auxiliary microscope having a relatively low magnification optical system relative to the probe microscope 10A, however, the present embodiment is not limited to this and, as is shown in FIG. 15, for example, it is also possible to use a normal microscope 20A1 instead. In FIG. 15, the symbol 21A1 is an illumination light source for illuminating the field of vision of the microscope 20A1, and the symbol 21B is a revolver having a plurality of objective lenses having different magnifications.

(Sixth Embodiment)

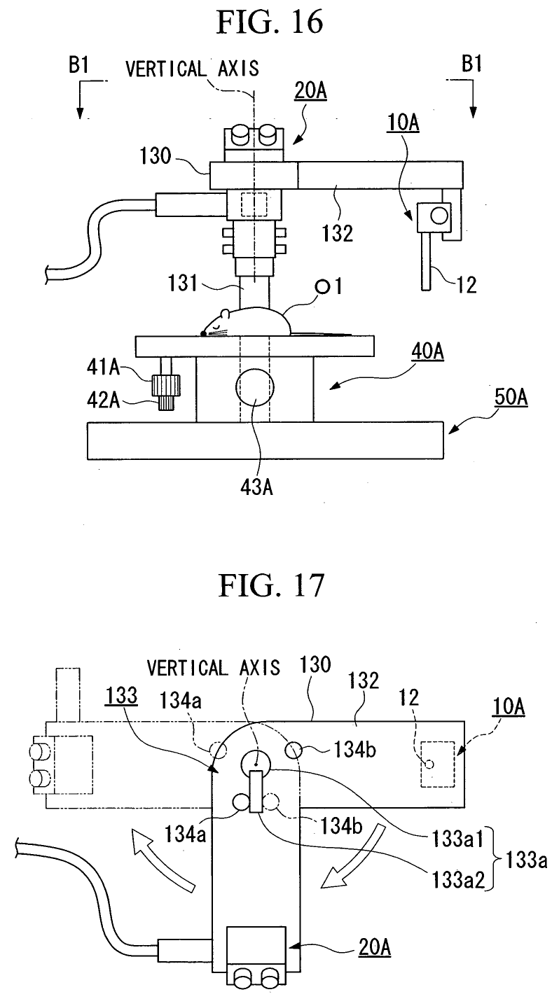

The sixth embodiment of the present invention will now be described referring to FIGS. 16 and 17. FIG. 16 is a frontal view showing the microscopic observing apparatus of the present embodiment. FIG. 17 is a view showing a portion of this microscopic observing apparatus, and is a plan view looking from the direction of B1-B1 in FIG. 16.

Note that in the description below, component elements that are the same as those in the fifth embodiment are given the same reference symbols and a detailed description thereof is omitted.

As is shown in FIG. 16, the microscopic observing apparatus of the present embodiment is provided with the probe microscope 10A that has a relatively high magnification optical system, the stereoscopic microscope (i.e., an auxiliary microscope) 20A that has a low magnification optical system, a microscope holding member (i.e., a first microscope holding member) 130 that rotatably supports the probe microscope 10A and the stereoscopic microscope 20A such that they can rotate around a vertical axis, the specimen stage 40A on which is placed a subject of observation O1 such as an experimental animal that is to be observed using the probe microscope 10A and the stereoscopic microscope 20A, and that allows the absolute position of the subject of observation O1 to be adjusted, and the base 50A on which the specimen stage 40A and the microscope holding member 130 are installed.

As is shown in FIG. 16, the microscope holding member 130 is provided with a supporting column 131 that stands vertically upright on the base 50A, a rotating member 132 that is connected to the top end of the supporting column 131 so as to be able to rotate around a vertical axis, and a restricting member (i.e., a third restricting member) 133 that positions the rotation position of the rotating member 132.

When the rotating member 132 is seen in plan view, as is shown in FIG. 17, it is an L-shaped flat plate. The probe microscope 10A is fixed to one end side thereof and the stereoscopic microscope 20A is fixed to the other end side thereof. The probe microscope 10A and the stereoscopic microscope 20A are fixed such that the respective optical axis positions thereof face in a vertical direction and are both at an equal distance from the vertical axis.

A through hole (not shown) having the same axis as the vertical axis is formed at a curving position of the rotating member 132. A supporting column side stopper 133a that is coaxial with the supporting column 131 is inserted in this through hole so as to protrude upwards above the rotating member 132. The supporting column side stopper 133a is provided with a shaft portion 133a1 that is shaped as a circular column, and a projecting portion 133a2 that protrudes horizontally along the top surface of the rotating member 132 above the shaft portion 133a1. The relative rotation of the projecting portion 133a2 around the vertical axis relative to the shaft portion 133a1 is fixed, and the position thereof is fixed in a state of protruding downwards in FIG. 17.

In contrast, as is shown in FIG. 17, a pair of stoppers 134a and 134b are provided standing upright on a top surface of the rotating member 132. When the rotating member 132 is rotated to the left in FIG. 17, the stopper 134a also rotates to the left around the vertical axis together with the rotating member 132. When the optical axis position of the stereoscopic microscope 20A accurately matches a predetermined position (for example, a center position on the placement surface) on the specimen stage 40A, the stopper 134a abuts against a side surface of the projecting portion 133a2 so that further rotation to the left of the stereoscopic microscope 20A is restricted.

In the same way, when the rotating member 132 is rotated to the right in FIG. 17, the stopper 134b also rotates to the right around the vertical axis together with the rotating member 132. When the optical axis position of the probe microscope 10A accurately matches a predetermined position (namely, matches the previously positioned optical axis position of the stereoscopic microscope 20A) on the specimen stage 40A, the stopper 134b abuts against the other side surface of the projecting portion 133a2 so that further rotation to the right of the probe microscope 10A is restricted.

A locking screw (not shown) is provided in the rotating member 132, and by tightening this locking screw, the rotation of the rotating member 132 is fixed. By loosening the locking screw, the rotation of the rotating member 132 is allowed.

Accordingly, the rotating member 132 rotatably holds the stereoscopic microscope 20A and the probe microscope 10A such that they can pass above the specimen stage 40A. In addition, when one of the two optical axes matches the predetermined position, the rotating member 132 is stopped, and by further fixing the rotation using the locking screw accurate positioning can be performed.

An observation method for observing the subject of observation O1 using the microscopic observing apparatus of the present embodiment having the above described structure will now be described.

Firstly, the subject of observation O1 is fixed in place on the specimen stage 40A. Next, the stereoscopic microscope 20A is rotated so as to approach a position directly above the subject of observation O1 on the specimen stage 40A. When the optical axis position of the stereoscopic microscope 20A reaches the predetermined position (i.e., a center position on the placement surface of the specimen stage 40A), the stopper 134a comes up against a side surface of the projecting portion 133a2, further rotation is restricted and the stereoscopic microscope 20A stops.

In this stopped state, the locking screw is operated so that the position of the stereoscopic microscope 20A is fixed. Macro observation using the stereoscopic microscope 20A is then performed and, if necessary, the adjustment knobs 41A, 42A, and 43A are operated thereby adjusting the absolute position of the subject of observation O1 such that the desired observation visual field is obtained.

During this positioning operation, laser light from the laser pointer light source 27A is irradiated onto the subject of observation O1, and by confirming the illumination position on the subject of observation O1 either by the naked eye or using the visual field of the stereoscopic microscope 20A, it is possible to visually confirm the position of the optical axis of the stereoscopic microscope 20A relative to the subject of observation O1. As a result of this operation, the relative positions between the optical axis position of the stereoscopic microscope 20A and the specimen stage 40A at the moment the desired observation visual field is obtained are accurately set.

Note that when the subject of observation O1 is a fluorescent sample, then by using an excitation wavelength for the wavelength of the laser light L, it is possible to perform positioning using fluorescent observation in addition to normal observation.

Next, after the position fixing of the stereoscopic microscope 20A using the locking screw has been released, this time the probe microscope 10A is rotated so as to approach the position of the subject of observation O1. At this time, because the stereoscopic microscope 20A is integrally connected to the probe microscope 10A via the rotating member 132, the stereoscopic microscope 20A is automatically withdrawn from above the specimen stage 40A. On the other hand, when the optical axis position of the probe microscope 10A reaches the predetermined position (i.e., the center position on the placement surface of the specimen stage 40A), the stopper 134b comes up against the other side surface of the projecting portion 133a2, further rotation is restricted and the probe microscope 10A stops.

In this stopped state, the locking screw is operated so that the position of the probe microscope 10A is fixed. As a result, the optical axis position when micro observation is performed using the probe microscope 10A can be automatically matched to the optical axis position when micro observation is performed using the stereoscopic microscope 20A (namely, to the predetermined position). Micro observation using the probe microscope 10A is then performed.

Note that when the subject of observation O1 is a fluorescent sample, then by making the wavelength of the laser light emitted from the laser light source 11 an excitation wavelength, it is possible to perform positioning using fluorescent observation in addition to normal observation.

According to the above described microscopic observing apparatus of the present embodiment, simply by rotating the stereoscopic microscope 20A and the probe microscope 10A using the microscope holding member 130, and by then stopping each at the respective observation positions in accordance with the restricting member 133, it is possible to automatically match the field of vision when performing micro observation using the probe microscope 10A with the observation field of vision when performing macro observation using the stereoscopic microscope 20A. Accordingly, when switching from macro observation to micro observation using a probe microscope 10A having a relatively high magnification optical system and a stereoscopic microscope 20A having a low magnification optical system, the probe microscope 10A can be easily and accurately positioned at the desired observation position.

Note that, in the present embodiment, a stereoscopic microscope 20A is employed as the auxiliary microscope having a relatively low magnification optical system relative to the probe microscope 10A, however, the present embodiment is not limited to this and, as is shown in FIG. 15, for example, it is also possible to use a normal microscope 20A1 instead.

(Seventh Embodiment)

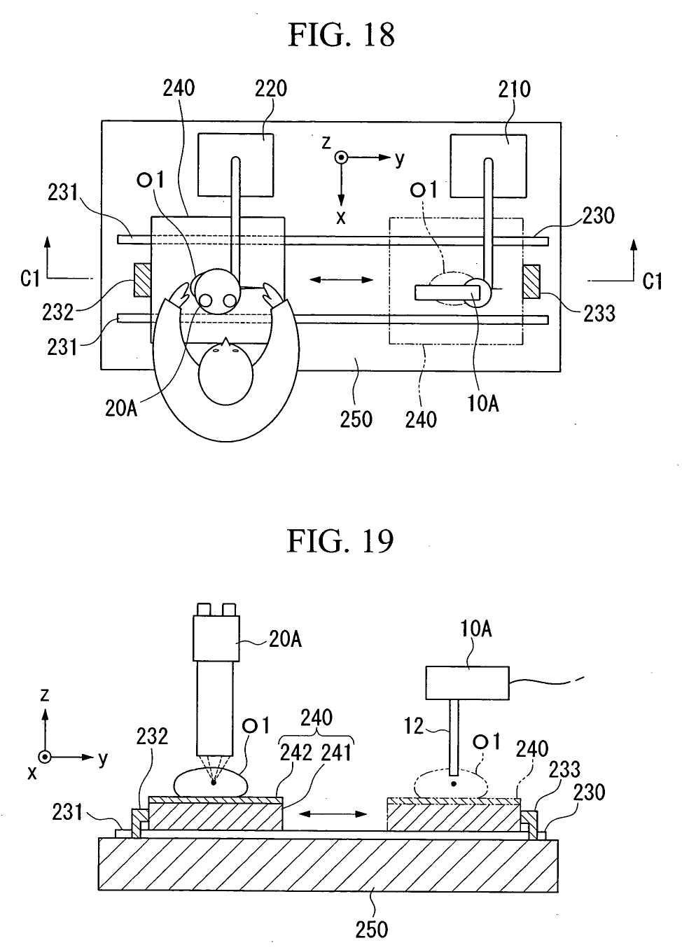

The seventh embodiment of the present invention will now be described referring to FIGS. 18 and 19. FIG. 18 is a plan view showing the microscopic observing apparatus of the present embodiment. FIG. 19 is a view showing this microscopic observing apparatus, and is a vertical cross-sectional view looking from the direction of C1-C1 in FIG. 18.

Note that in the description below, component elements that are the same as those in the fifth embodiment are given the same reference symbols and a detailed description thereof is omitted.

As is shown in FIG. 18, the microscopic observing apparatus of the present embodiment is provided with the probe microscope 10A that has a relatively high magnification optical system, the stereoscopic microscope (i.e., an auxiliary microscope) 20A that has a low magnification optical system, microscope holding mechanisms 210 and 220 that respectively support the probe microscope 10A and the stereoscopic microscope 20A, a specimen stage 240 on which is placed a subject of observation O1 such as an experimental animal that is to be observed using the probe microscope 10A and the stereoscopic microscope 20A, and that allows the absolute position of the subject of observation O1 to be adjusted, a guide mechanism 230 that guides the specimen stage 240 such that it can move between the respective optical axis positions of the probe microscope 10A and the stereoscopic microscope 20A, and a base 250 on which the microscope holding mechanisms 210 and 220 as well as the specimen stage 240 and guide mechanism 230 are installed.

As is shown in FIGS. 18 and 19, the guide mechanism 230 is provided with a pair of guide rails (i.e., a second guide) 231, a left stopper (i.e., a fourth restricting member) 232 that restricts further movement of the specimen stage 240 when a predetermined position (described below) on the specimen stage 240 arrives at the optical axis position of the stereoscopic microscope 20A, and a right stopper (i.e., a fifth restricting member) 233 that restricts further movement of the specimen stage 240 when the predetermined position on the specimen stage 240 arrives at the optical axis position of the probe microscope 10A.

Each of the guide rails 231 extends across the base 250 between a position directly beneath the probe microscope 10A and a position directly beneath the stereoscopic microscope 20A, and has the function of guiding the specimen stage 40 when the specimen stage 40 is roughly positioned between a position directly beneath the probe microscope 10A and a position directly beneath the stereoscopic microscope 20A.

As is shown in FIG. 19, the specimen stage 240 has a rough movement stage 241 that moves along the respective guide rails 231, a precise movement stage 242 whose relative position in the horizontal direction relative to the rough movement stage 241 can be precisely adjusted and on which the subject of observation O1 is placed, and a locking screw (not shown) that either fixes the relative position of the rough movement stage 241 relative to the guide rails 231 or allows this relative position to be changed.

The predetermined position is set for the rough movement stage 241 and not for the precise movement stage 242. In the present embodiment, in an initial state in which the precise movement stage 242 is not moved relatively to the rough movement stage 241, when looking at the rough movement stage 241 in plan view, this predetermined position is set as a position that corresponds to the center position on the placement surface of the precise movement stage 242.

The precise movement stage 242 is an XY stage. By operating adjustment knobs (not shown), it is possible to precisely adjust the position of the precise movement stage 242 in the left and right directions and upward and downward directions in FIG. 18.

When the specimen stage 240 is roughly moved to the left as seen in FIGS. 18 and 19, the left stopper 232 has the function of restricting further movement to the left of the specimen stage 240 by abutting against one side surface of the rough movement stage 241.

In contrast, when the specimen stage 240 is roughly moved to the right as seen in FIGS. 18 and 19, the right stopper 233 has the function of restricting further movement to the right of the specimen stage 240 by abutting against the other side surface of the rough movement stage 241.

The microscope holding mechanism 210 is provided with a Z stage that is fixed to the base 250 and a θ stage that is fixed to the Z stage and holds the probe 12, and is able to move the probe 12 up and down and to tilt the probe 12 in a θx direction and in a θy direction (i.e., to the left and right looking at FIG. 19 and in a direction perpendicular to the surface of the paper showing FIG. 19).

The microscope holding mechanism 220 is provided with a Z stage that is fixed to the base 250, and is able to move the stereoscopic microscope 20A up and down.

An observation method for observing the subject of observation O1 using the microscopic observing apparatus of the present embodiment having the above described structure will now be described.

Firstly, the subject of observation O1 is fixed in place on the specimen stage 240. Next, the specimen stage 240 is moved so as to approach a position directly below the stereoscopic microscope 20A. When the predetermined position of the specimen stage 240 (i.e., a central position on the rough movement stage 241) matches the optical axis position of the stereoscopic microscope 20A, the left stopper 232 abuts against one side surface of the rough movement stage 241 so that further movement is restricted and the specimen stage 240 stops.

In this stopped state, the locking screw is operated so that the position of the specimen stage 240 is fixed (namely, the position of the rough movement stage 241 is fixed). Macro observation using the stereoscopic microscope 20A is then performed and, if necessary, by operating the adjustment knobs the absolute position of the subject of observation O1 is adjusted such that the desired observation visual field is obtained.

During this positioning operation, laser light from the laser pointer light source 27A is irradiated onto the subject of observation O1, and by confirming the illumination position on the subject of observation O1 either by the naked eye or using the visual field of the stereoscopic microscope 20A, it is possible to visually confirm the position of the optical axis of the stereoscopic microscope 20A relative to the subject of observation O1. As a result of this operation, the relative positions between the optical axis position of the stereoscopic microscope 20A and the specimen stage 240 at the moment the desired observation visual field is obtained are accurately positioned.

Note that when the subject of observation O1 is a fluorescent sample, then by using an excitation wavelength for the wavelength of the laser light L, it is possible to perform positioning using fluorescent observation in addition to normal observation.

Next, after the position fixing of the specimen stage 240 by the locking screw has been released, this time the specimen stage 240 is moved so as to approach a position directly below the probe microscope 10A. When the predetermined position of the specimen stage 240 (i.e., a central position on the rough movement stage 241) matches the optical axis position of the probe microscope 10A, the right stopper 233 abuts against the other side surface of the rough movement stage 241 so that further movement is restricted and the specimen stage 240 stops.

In this stopped state, the locking screw is operated so that the position of the specimen stage 240 is fixed (namely, the position of the rough movement stage 241 is fixed). As a result, the optical axis position when micro observation is performed using the probe microscope 10A can be automatically matched to the optical axis position that is focused on the precise movement stage 242 when macro observation is performed using the stereoscopic microscope 20A. Micro observation using the probe microscope 10A is then performed.

According to the above described microscopic observing apparatus of the present embodiment, simply by moving the stereoscopic microscope 20A and the probe microscope 10A along the respective guide rails 231, and by then stopping each in accordance with the left stopper 232 and the right stopper 233, it is possible to match the visual field when performing micro observation using the probe microscope 10A automatically with the center of the observation visual field when performing macro observation using the stereoscopic microscope 20A. Accordingly, when switching from macro observation to micro observation using the probe microscope 10A having a relatively high magnification optical system and the stereoscopic microscope 20A having a low magnification optical system, the probe microscope 10A can be easily and accurately positioned at the desired observation position.

Note that in the present embodiment, a stereoscopic microscope 20A is employed as the auxiliary microscope having a relatively low magnification optical system relative to the probe microscope 10A, however, the present embodiment is not limited to this and, as is shown in FIG. 15, for example, it is also possible to use a normal microscope 20A1 instead.

(Eighth Embodiment)

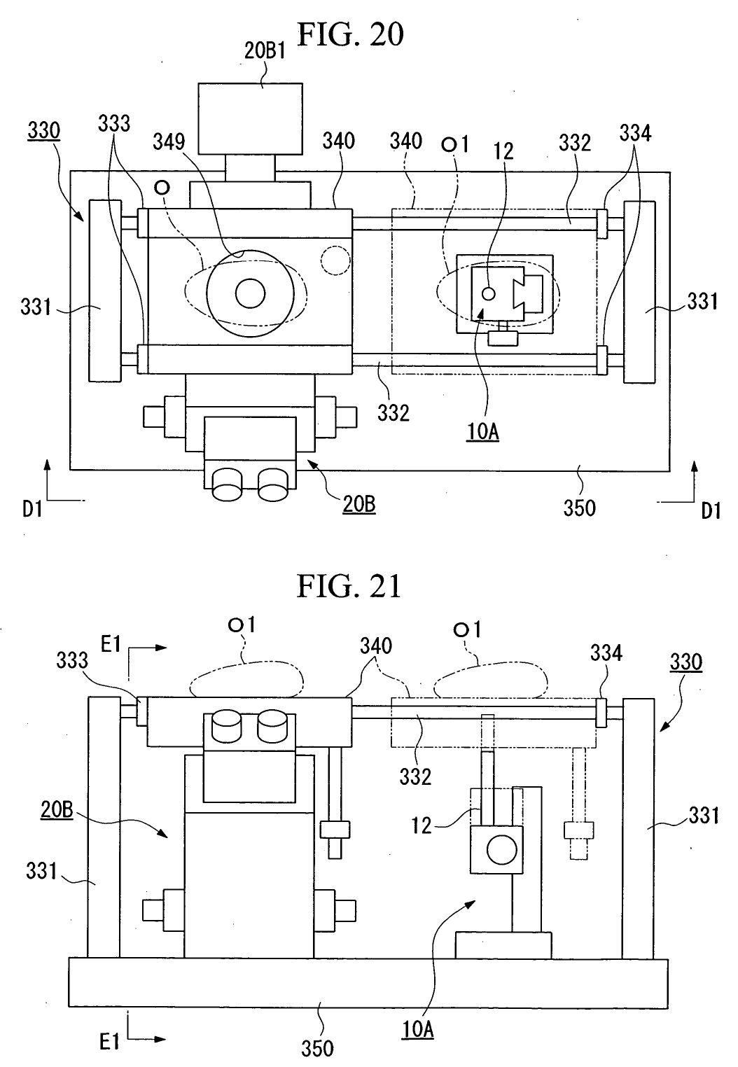

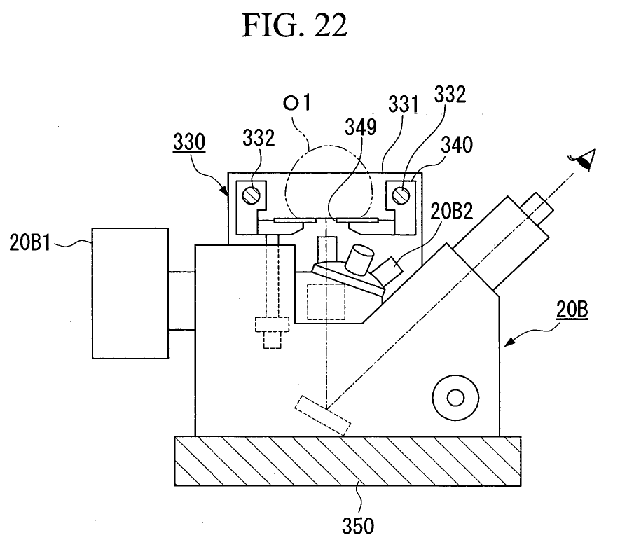

The eighth embodiment of the present invention will now be described referring to FIGS. 20 to 22. FIG. 20 is a plan view showing the microscopic observing apparatus of the present embodiment. FIG. 21 is a view showing this microscopic observing apparatus, and is a frontal view looking from the direction of D1-D1 shown in FIG. 20. FIG. 22 is a view showing this microscopic observing apparatus, and is a vertical cross sectional view looking from the direction of E1-E1 shown in FIG. 21.

Note that in the description below, component elements that are the same as those in the fifth embodiment are given the same reference symbols and a detailed description thereof is omitted.

As is shown in FIGS. 20 to 22, the microscopic observing apparatus of the present embodiment is provided with a probe microscope 10A that has a relatively high magnification optical system, a normal microscope (i.e., an auxiliary microscope) 20B that has a low magnification optical system, a specimen stage 340 on which is placed a subject of observation O1 that is to be observed using the probe microscope 10A and the normal microscope 20B, and that allows the absolute position of the subject of observation O1 to be adjusted, a guide mechanism 330 that guides the specimen stage 340 such that it can move between the respective optical axis positions of the probe microscope 10A and the normal microscope 20B, and a base 350 on which the microscope 20B, the probe microscope 10A and the guide mechanism 330 are installed.

The microscope 20B is a normal microscope having substantially the same structure as the microscope 20A1 shown in FIG. 15, and is provided with an illumination light source 20B1 for illuminating the field of vision and a revolver 20B2 having a plurality of ocular lenses each having a different magnification. However, as is shown in FIG. 22, the microscope 20B of the present embodiment differs from the microscope 20A1 in that is possible to observe the subject of observation O1 from a line of site that looks upwards from below the subject of observation O1.

In addition, the probe microscope 10A is supported by the Z stage 310 such that the optical axis thereof faces vertically upwards. Accordingly, in the same way as the microscope 20B, the probe microscope 10A of the present embodiment is able to observe the subject of observation O1 from a line of site that looks upwards from below the subject of observation O1.

As is shown in FIG. 20 to FIG. 22, the guide mechanism 330 is provided with a pair of column members 331 that stand upright at the left and right ends of the base 350, the pair of guide rails 332 that extend between the respective top ends of the column members 331, a left stopper (i.e., a fourth restricting member) 333 that restricts further movement of the specimen stage 340 when a predetermined position (described below) on the specimen stage 340 arrives at the optical axis position of the microscope 20B, and a right stopper (i.e., a fifth restricting member) 334 that restricts further movement of the specimen stage 340 when the predetermined position on the specimen stage 340 arrives at the optical axis position of the probe microscope 10A.

As is shown in FIG. 22, each of the guide rails 332 penetrates a pair of through holes formed in the specimen stage 340, and has the function of guiding the specimen stage 340 such that it can move in one direction (i.e., in the left and right direction in FIGS. 20 and 21) above the probe microscope 10A and the microscope 20B.

Although omitted from the drawings, the specimen stage 340 has a rough movement stage that moves along the respective guide rails 332, a precise movement stage whose relative position in the horizontal direction relative to the rough movement stage can be precisely adjusted and on which the subject of observation O1 is placed, and a locking screw (not shown) that either fixes the relative position of the rough movement stage relative to the guide rails 332 or allows this relative position to be changed.

The predetermined position is set for the rough movement stage and not for the precise movement stage. In the present embodiment, in an initial state in which the precise movement stage is not moved relatively to the rough movement stage, when looking at the rough movement stage in plan view, this predetermined position is set as a position that corresponds to the center position on the placement surface of the precise movement stage.

The precise movement stage is an XY stage. By operating adjustment knobs (not shown), it is possible to precisely adjust the position of the precise movement stage in the left and right directions and upward and downward directions in FIG. 20.

As is shown in FIG. 20 and FIG. 22, an aperture portion 349 is formed in both the rough movement stage and the precise movement stage so as to penetrate these in a vertical direction. As a result, the probe microscope 10A and the microscope 20B are able to observe a bottom portion of the subject of observation O1 from below the specimen stage 340 via the aperture portions 349.

When the specimen stage 340 is roughly moved to the left as seen in FIGS. 20 and 21, the left stopper 333 has the function of restricting further movement to the left of the specimen stage 340 by abutting against one side surface of the rough movement stage.

In contrast, when the specimen stage 340 is roughly moved to the right as seen in FIGS. 20 and 21, the right stopper 334 has the function of restricting further movement to the right of the specimen stage 340 by abutting against the other side surface of the rough movement stage.

An observation method for observing the subject of observation O1 using the microscopic observing apparatus of the present embodiment having the above described structure will now be described.

Firstly, the subject of observation O1 is fixed in place on the specimen stage 340. Next, the specimen stage 340 is moved so as to approach a position directly above the microscope 20B. When the predetermined position of the specimen stage 340 (i.e., a central position on the rough movement stage) matches the optical axis position of the microscope 20B, the left stopper 333 abuts against one side surface of the rough movement stage so that further movement is restricted and the specimen stage 340 stops.

In this stopped state, the locking screw is operated so that the position of the specimen stage 340 is fixed (namely, the position of the rough movement stage is fixed). Macro observation looking upwards via the aperture portion 349 is then performed using the microscope 20B and, if necessary, by operating the adjustment knobs, the absolute position of the subject of observation O1 is adjusted such that the desired observation visual field is obtained.

As a result of the above operation, the relative positions between the optical axis position of the microscope 20B and the specimen stage 340 at the moment when the desired observation visual field is obtained are accurately set.

Next, after the fixing of the position of the specimen stage 340 using the locking screw has been released, this time the specimen stage 340 is moved so as to approach a position directly above the probe microscope OA. When the predetermined position of the specimen stage 340 (i.e., a central position on the rough movement stage) matches the optical axis position of the probe microscope 10A, the right stopper 334 abuts against the other side surface of the rough movement stage so that further movement is restricted and the specimen stage 340 stops.

In this stopped state, the locking screw is operated so that the position of the specimen stage 340 is fixed (namely, the position of the rough movement stage is fixed). As a result, the optical axis position when micro observation is performed using the probe microscope 10A can be automatically matched to the optical axis position that is focused on the precise movement stage when macro observation is performed using the microscope 20B. In this state, micro observation looking upwards via the aperture portion 349 is performed.

According to the above described microscopic observing apparatus of the present embodiment, simply by moving the specimen stage 340 along the respective guide rails 332, and by then stopping the specimen stage 340 in accordance with the left stopper 333 and the right stopper 334, it is possible to automatically match the optical axis position when performing micro observation using the probe microscope 10A with the optical axis position when performing macro observation using the microscope 20B. Accordingly, when switching from macro observation to micro observation using the probe microscope 10A having a relatively high magnification optical system and the microscope 20B having a low magnification optical system, the probe microscope 10A can be easily and accurately positioned at the desired observation position.

Furthermore, because it is possible to make an observation by looking up at the specimen stage 340 through the aperture portion 349 from below the specimen stage 340, when, for example, performing in-vivo observation of the internal organs of an experimental animal by opening up the abdomen and the like thereof, it is possible to observe the experimental animal as it is in a natural attitude without having to turn the experimental animal over. Accordingly, it is possible to perform in-vivo observation that is nearer to a natural state because there is no need to change the state of the experimental animal by turning the experimental animal over.

Note that in the present embodiment, the normal microscope 20B is employed as the auxiliary microscope having a relatively low magnification optical system relative to the probe microscope 10A, however, the present embodiment is not limited to this and, for example, it is also possible to use a stereoscopic microscope instead.

(Ninth Embodiment)

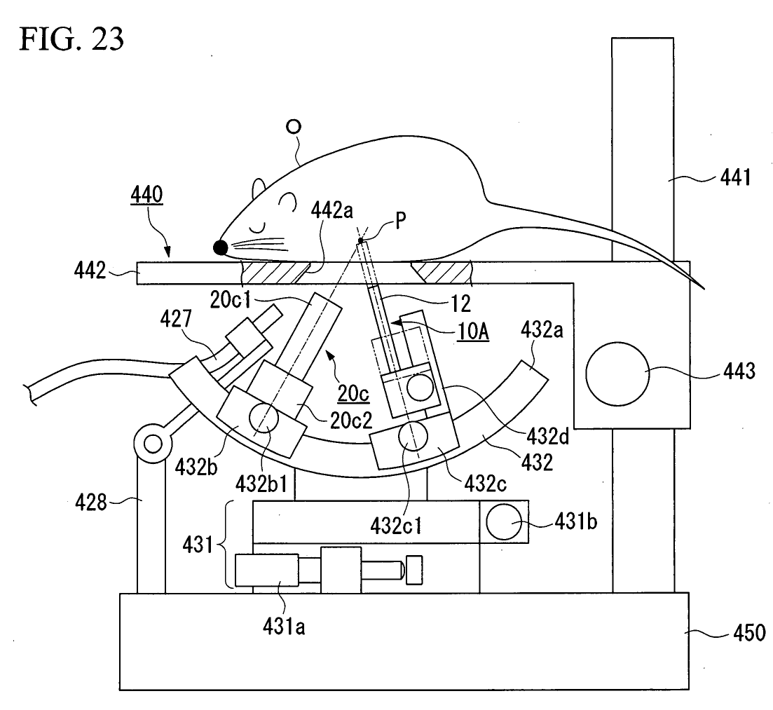

The ninth embodiment of the present invention will now be described referring to FIG. 23. FIG. 23 is a frontal view showing the microscopic observing apparatus of the present embodiment.

Note that in the description below, component elements that are the same as those in the fifth embodiment are given the same reference symbols and a detailed description thereof is omitted.

As is shown in FIG. 23, the microscopic observing apparatus of the present embodiment is provided with the probe microscope 10A having a relatively high magnification optical system, a video microscope (i.e., an auxiliary microscope) 20C having a low magnification optical system, a θ stage (i.e., a second microscope holding member) 432 that holds the probe microscope 10A and the video microscope 20C, a laser pointer 427 that irradiates laser light onto a position where the optical axis of the video microscope 20C meets the subject of observation O1, a fiber supporting member 428 that holds the laser pointer 427, a specimen stage 440 on which is placed the subject of observation O1 that is observed by the probe microscope 10A and the video microscope 20C, an XY stage (i.e., an adjustment device) 431 that adjusts relative positions between the specimen stage 440, the probe microscope 10A, and the video microscope 20C, and a base 450 on which the XY stage 431, the specimen stage 440, and the fiber supporting member 428 are installed.

The video microscope 20C is an image pickup device formed by combining a macro lens 20C1 and a CCD camera 20C2. The video microscope 20C is able to output an image of the observation visual field on a display (not shown).

The specimen stage 440 is provided with a supporting column 441 standing upright on the base 450, a Z stage 442 that is able to be precisely adjusted in the Z axial direction (i.e., in a vertical direction in FIG. 23) along the supporting column 441, and an adjustment knob 443 for precise adjustment of the vertical movement of the Z stage 442. An aperture portion 442a that penetrates the Z stage 442 in the vertical direction is formed at a central position in the Z stage 442. Accordingly, it is possible to observe from below the subject of observation O1 placed on the Z stage 442.

By operating adjustment knobs 431a and 431b, the XY stage 431 is able to precisely adjust the position of the θ stage 432 in the XY directions (namely, to the left and right looking at FIG. 23 and in a direction perpendicular to the surface of the paper showing FIG. 23).

The θ stage 432 is provided with a circular arc shaped guide 432a that is fixed to the XY stage 431, a pair of sliders 432b and 432c that move along the guide 432a, and a Z stage 432d that is fixed to one of the sliders 432c. The guide 432a is positioned such that the center of the circular arc shape thereof is the observation position for observing the subject of observation O1. Each slider 432b and 432c is mounted on the guide 432a such that, by operating the adjustment knobs 432b1 and 432c1, the sliders 432a and 432b are able to move along the circular arc shape. Locking screws (not shown) are provided in each of the sliders 432b and 432c and the position of each slider 432b and 432c on the guide 432a can be fixed.

Moreover, using the θ stage 432, the probe microscope 10A and the video microscope 20C can be held underneath the Z stage 442 such that the optical axes of each pass through the aperture portion 442a and intersect at a position on the subject of observation O1 (i.e., the same position as the center P).

An observation method for observing the subject of observation O1 using the microscopic observing apparatus of the present embodiment having the above described structure will now be described.

Firstly, the subject of observation O1 is placed on the Z stage 442 and macro observation is performed using the video microscope 20C. At this time, if necessary, the XY stage 431, the θ stage 432, and the Z stage 442 are operated and adjusted so that the desired observation field of vision can be obtained. During this positioning operation, laser light from the laser pointer 427 is irradiated onto the subject of observation O1 and by confirming the irradiation position on the subject of observation O1 using the visual field of the video microscope 20C, it is possible to visually confirm the position of the optical axis of the video microscope 20C with on the subject of observation O1.

As a result of this operation, the relative positions between the optical axis position of the video microscope 20C and the Z stage 442 at the moment the desired observation visual field is obtained can be accurately set.

Next, micro observation using the probe microscope 10A is performed. Because the optical axis of the probe microscope 10A and the optical axis of the video microscope 20C have been set in advance so as to intersect at a position on the subject of observation O1, the positioning operation to match the optical axis position of the probe microscope 10A with the optical axis position of the video microscope 20C is unnecessary. Moreover, as is described above, the relative positions between the optical axis of the video microscope 20C and the Z stage 442 have already been accurately set. Accordingly, any further operation to position the Z stage 442 is unnecessary, and micro observation using the probe microscope 10A can be performed in this state.

Furthermore, because it is possible to make an observation by looking up at the Z stage 442 through the aperture portion 442a from below the Z stage 442, when, for example, performing in-vivo observation of the internal organs of an experimental animal by opening up the abdomen and the like thereof, it is possible to observe the experimental animal as it is in a natural attitude without having to turn the experimental animal over.

According to the above described microscopic observing apparatus of the present embodiment, because the probe microscope 10A and the video microscope 20C are supported by the θ stage 432 such that the optical axes of each intersect at a position on the subject of observation O1, when performing macro observation using the video microscope 20C, once the relative position of the Z stage 442 has been set relative to the optical axis of the video microscope 20C using the XY stage 431, at the same time, the relative position of the Z stage 442 is also accurately set relative to the optical axis of the probe microscope 10A. Accordingly, when switching from macro observation to micro observation using the probe microscope 10A having a relatively high magnification optical system and the video microscope 20C having a low magnification optical system, the probe microscope 10A can be easily and accurately positioned at the desired observation position.

Furthermore, when, for example, performing in-vivo observation of the internal organs of an experimental animal by opening up the abdomen and the like thereof, it is possible to observe the experimental animal as it is in a natural attitude without having to turn the experimental animal over. Accordingly, it is possible to perform in-vivo observation that is nearer to a natural state because there is no need to change the state of the experimental animal by turning the experimental animal over.

Note that in the present embodiment, the video microscope 20C is employed as the auxiliary microscope having a relatively low magnification optical system relative to the probe microscope 10A, however, the present embodiment is not limited to this and, for example, it is also possible to use another type of microscope instead.

(Tenth Embodiment)

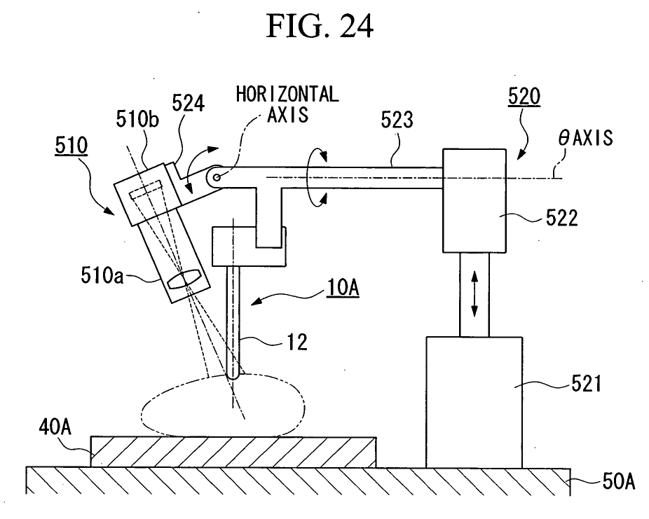

The tenth embodiment of the present invention will now be described referring to FIG. 24. FIG. 24 is a frontal view showing a tenth embodiment of the microscopic observing apparatus of the present invention.

Note that in the description below, component elements that are the same as those in the fifth embodiment are given the same reference symbols and a detailed description thereof is omitted.

As is shown in FIG. 24, the microscopic observing apparatus of the present embodiment is provided with the probe microscope 10A that has a relatively high magnification optical system, a video microscope (i.e., an auxiliary microscope) 510 that has a low magnification optical system, a microscope holding mechanism (i.e., a third microscope holding member) 520 that holds both the probe microscope 10A and the video microscope 510, the specimen stage 40A on which is placed a subject of observation O1 that is to be observed using the probe microscope 10A and the video microscope 510, and the base 50A on which the specimen stage 40A and the microscope holding mechanism 520 are installed.

The video microscope 510 is an image pickup device formed by combining a macro lens 510a and a CCD camera 510b. The video microscope 510 is able to output an image of the observation visual field is on a display (not shown).

The microscope holding mechanism 520 is provided with a Z stage 521 that stands upright on the base 50A, a θ stage 522 that is mounted on a top end of the Z stage 521, an arm 523 that extends horizontally towards an area above the specimen stage 40A from the θ stage 522, a rotating member 524 that is rotatably linked to a distal end of the arm 523 so as to be able to rotate around a horizontal axis, and a locking screw (not shown) that fixes the rotation position of the rotation member 524 or allows this position to be changed.

The probe microscope 10A is held below the distal end of the arm 523 so that the optical axis of the probe 12 faces vertically downwards onto the specimen stage 40A. The video microscope 510 is mounted on the rotating member 524 such that the optical axis thereof intersects with the optical axis of the probe 12, and also such that an image of the distal end of the probe 12 appears at a substantially central position in the visual field of the video microscope 510.

The Z stage 521 is able to precisely adjust the height position of the probe microscope 10A and microscope 510 relative to the specimen stage 40A by adjusting the height position of the θ stage 522 (i.e., a position in the vertical direction in FIG. 24).

The θ stage 522 is able to precisely adjust the tilt angle of the optical axes of the probe microscope 10A and microscope 510 relative to the specimen stage 40A by rotating the arm 523 around the θ axis that is formed coaxially with the arm 523.

An observation method for observing the subject of observation O1 using the microscopic observing apparatus of the present embodiment having the above described structure will now be described.

Firstly, the subject of observation O1 is placed on the specimen stage 40A and macro observation is performed using the video microscope 510. At this time, if necessary, the specimen stage 40A, the Z stage 521, and the θ stage 522 are operated and adjusted so that the desired observation field of vision can be obtained. Even if this type of adjustment is performed, because the probe microscope 10A and the video microscope 510 are held by the common arm 523, the relative positional relationship between the optical axes thereof will not change. Moreover, because an image of the distal end of the probe 12 constantly appears in the center of the visual field of the video microscope 510 during this adjustment, it is possible to make an observation while constantly confirming the position of the distal end of the probe 12 relative to the observation position of the macro observation currently being performed.

Next, micro observation using the probe microscope 10A is performed. Because the optical axis of the probe microscope 10A and the optical axis of the video microscope 510 have been preset so as to intersect, the positioning operation to precisely adjust the optical axis of the probe microscope 10A in the XY directions (i.e., in the horizontal directions) is unnecessary. Accordingly, micro observation can be performed simply by precisely adjusting the height position of the probe microscope 10A as is necessary using the Z stage 521.

Note that, as a device for simplifying the positioning operation during macro observation, it is possible to employ a structure in which a laser light illumination device (for example, see the eleventh embodiment described hereinafter) is provided that irradiates laser light that is coaxial with the optical axis of the probe 12 onto the observation position of the subject of observation O1, and to confirm this irradiation position using the visual field of the video microscope 510. At this time, if the subject of observation O1 is a fluorescent sample, then by using an excitation wavelength for the wavelength of the laser light L, it is possible to perform positioning using fluorescent observation in addition to normal observation.

According to the above described microscopic observing apparatus of the present embodiment, because the probe microscope 10A and the video microscope 510 are held by a common microscope holding mechanism 520, and additionally, because the optical axes thereof intersect, once the subject of observation O1 has been positioned in the observation position during macro observation by the video microscope 510, at the same time the relative position in the XY directions of the probe microscope 10A relative to the observation position of the subject of observation O1 is also accurately set. Accordingly, when switching from macro observation to micro observation using the probe microscope 10A having a relatively high magnification optical system and the video microscope 510 having a low magnification optical system, the probe microscope 10A can be easily and accurately positioned at the desired observation position.

Furthermore, because the video microscope 510 is employed as the auxiliary microscope, it is possible to reduce the size of the auxiliary microscope. Accordingly, it is possible for both the video microscope 510 and the probe microscope 10A to be held by the microscope holding mechanism 520, and for the size of the apparatus as a whole to be reduced.

Note that in the present embodiment, by operating the locking screw, the video microscope 510 is able to be rotated together with the rotating member 524 around a horizontal axis, however, they may also be fixed provided that the video microscope 510 does not become an obstruction during an observation by the probe microscope 10A.

(Eleventh Embodiment)

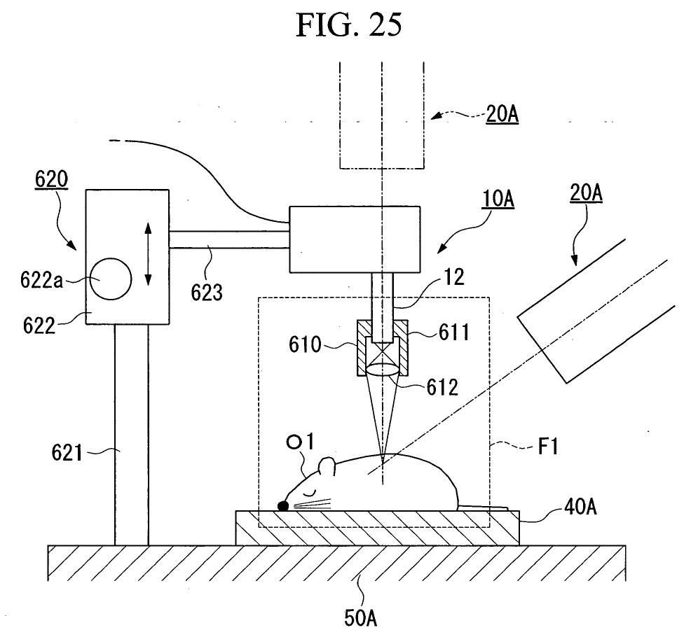

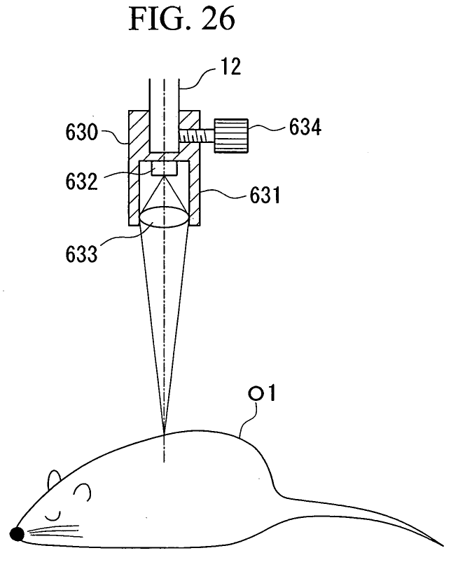

The eleventh embodiment of the present invention will now be described referring to FIG. 25 and FIG. 26. FIG. 25 is a frontal view showing the microscopic observing apparatus of the present embodiment. FIG. 26 is a view showing another example of this microscopic observing apparatus, and is a view corresponding to a portion F1 shown in FIG. 25.

Note that in the description below, component elements that are the same as those in the fifth embodiment are given the same reference symbols and a detailed description thereof is omitted.

As is shown in FIG. 25, the microscopic observing apparatus of the present embodiment is provided with the probe microscope 10A that has a relatively high magnification optical system, the stereoscopic microscope (i.e., an auxiliary microscope) 20A that has a low magnification optical system, the specimen stage 40A on which is placed a subject of observation O1 such as an experimental animal that is to be observed using the probe microscope 10A and the stereoscopic microscope 20A, and that allows the absolute position of the subject of observation O1 to be adjusted, a laser pointer adaptor (i.e., a second laser light irradiation device) 610 that irradiates laser light that is coaxial with the optical axis of the probe microscope 10A onto the subject of observation, a stereoscopic microscope holding mechanism (not shown) that supports the stereoscopic microscope 20A such that laser light irradiated onto the subject of observation O1 can be seen, a probe microscope holding mechanism 620 that holds a probe microscope, and the base 50A on which the probe microscope holding mechanism 620, the specimen stage 40A, and the stereoscopic microscope holding mechanism are installed.

The probe microscope holding mechanism 620 is provided with a support column 621 that stands upright on the base 50A, a Z stage 622 that is able to move up and down along the support column 621, and an arm 623 that extends horizontally towards an area above the specimen stage 40A from the Z stage 622. The probe microscope 10A is fixed to a distal end of the arm 623 such that the optical axis of the probe 12 faces onto the specimen stage 40A vertically beneath it.

By operating the adjustment knob 622a, the position of the Z stage 622 in a vertical direction is able to be precisely adjusted. As a result, the height position of the probe 12 relative to the top surface of the specimen stage 40A can be precisely adjusted.

The laser pointer adapter 610 is an optical component that is able to be mounted on and removed from a distal end of the probe 12, and is provided with a hollow, cylindrical adapter body 611 that is mounted on the distal end of the probe 12, and a condensing lens 612 that is held inside the adapter body 611.

The adapter body 611 holds the condensing lens 612 such that the optical axis of the condensing lens 612 matches the optical axis of the probe 12, and also such that laser light irradiated from the probe 12 is condensed at an observation position on the subject of observation O1 by the condensing lens 612. The method of fixing the adapter body 611 to the probe 12 may be one in which a locking screw (not shown) is provided in the adapter body 611 for fixing the adapter body 611, or one in which a hole is formed in the adaptor body 611 into which the probe 12 fits tightly, and the probe 12 is simply inserted in this hole.

As is shown in FIG. 25, when seen in frontal view, the stereoscopic microscope holding mechanism holds the stereoscopic microscope 20A (i.e., the one shown by a solid line) on the base 50A such that the optical axis of the stereoscopic microscope 20A is inclined so that the field of vision is not obstructed by the probe 12 and the laser pointer adaptor 610. Furthermore, the stereoscopic microscope holding mechanism holds the stereoscopic microscope 20A such that the optical axis of the stereoscopic microscope 20A matches an irradiation position onto which laser light from the probe 12 and laser pointer adaptor 610 is irradiated.

Note that, as another structure for ensuring that the field of vision of the stereoscopic microscope 20A is in no way obstructed by the probe 12 and the laser pointer adapter 610, as is shown by the double dot chain line in FIG. 25, placing the stereoscopic microscope 20A at a position directly above the probe microscope 10A, and also placing the probe microscope 10A within the dead angle region of the field of vision of the stereoscopic microscope 20A may be considered. More specifically, the stereoscopic microscope 20A is held such that the two optical axes of the stereoscopic microscope 20A are arranged with an interval between them as seen from a direction perpendicular to the surface of the paper showing FIG. 25, and the optical axis of the probe 12 matches a center position between these optical axes.

An observation method for observing the subject of observation O1 using the microscopic observing apparatus of the present embodiment having the above described structure will now be described. Firstly, macro observation is performed using the stereoscopic microscope 20A while laser light from the probe 12 and laser pointer adaptor 610 is irradiated onto the subject of observation O1 on the specimen stage 40A. The adjustment knobs 41A, 42A, and 43A are then operated such that the laser light strikes the desired observation position while the laser light irradiation position is being confirmed using the stereoscopic microscope 20A. As a result of this operation, because it is possible for the optical axis of the probe microscope 10A to be accurately positioned at the desired observation position, micro observation using the probe microscope 10A can be subsequently performed.

Note that if the subject of observation O1 is a fluorescent sample, then by using an excitation wavelength for the wavelength of the laser light L, it is possible to perform positioning using fluorescent observation in addition to normal observation.

Next, micro observation using the probe microscope 10A is performed. Before this, however, the laser pointer adapter 610 is removed from the probe 12. Thereafter, by operating the adjustment knob 622a, positioning of the probe 12 in the Z axial direction is performed. Because positioning in the XY directions (i.e., in the horizontal directions) was completed during the macro observation, it is not necessary here.

According to the above described microscopic observing apparatus of the present embodiment, by providing the apparatus with the laser pointer adapter 610, because it is possible to carry out the operation to position the optical axis of the probe microscope 10A while visually confirming the optical axis position of the probe microscope 10A relative to the observation position of the subject of observation O1 using the stereoscopic microscope 20A, the operation to position the optical axis in order to perform micro observation can be performed more simply and in a shorter time.

Accordingly, when switching from macro observation to micro observation using the probe microscope 10A having a relatively high magnification optical system and the stereoscopic microscope 20A having a low magnification optical system, the probe microscope 10A can be easily and accurately positioned at the desired observation position.

Note that, in the present embodiment, a stereoscopic microscope 20A is employed as the auxiliary microscope having a relatively low magnification optical system relative to the probe microscope 10A, however, the present embodiment is not limited to this and, as is shown in FIG. 15, for example, it is also possible to use a normal microscope 20A1 instead. However, in this case, it is necessary to tilt the microscope 20A1 so that it is possible to confirm the laser light irradiation position on the subject of observation O1 without this being obstructed by the probe microscope 10A.

Moreover, in the present embodiment, laser light emitted from the probe 12 is used as the light source for the laser light that is coaxial with the probe microscope 10A, however, the present embodiment is not limited to this and, as is shown in FIG. 26, for example, the light source may also be provided on the laser pointer adapter side. Namely, a laser pointer adapter 630 shown in FIG. 26 is an optical component that is able to be mounted on and removed from a distal end of the probe 12, and is provided with a hollow, cylindrical adapter body 631 that is mounted on the distal end of the probe 12, a light source chip 632 that is held inside the adapter body 631, a condensing lens 633 that is also held inside the adapter body 631, and a locking screw 634.

The adapter body 631 holds the condensing lens 633 such that the optical axis of the condensing lens 633 matches the optical axis of the probe 12, and also such that laser light irradiated from the probe 12 is condensed at an observation position on the subject of observation O1 by the condensing lens 633. The fixing of the adapter body 631 to the probe 12 is performed by fastening the locking screw 634.

An LED or a laser diode is preferably used as the light source chip 632. In particular, when a light source having a short wavelength (such as an LED in which λ=470 nm or 524 nm, or a laser diode in which λ=405 nm) is used, by providing a barrier filter (not shown) on the stereoscopic microscope 20A side, it is possible to observe a fluorescent image of the laser light irradiation position on the stereoscopic microscope 20A side.

(Twelfth Embodiment)

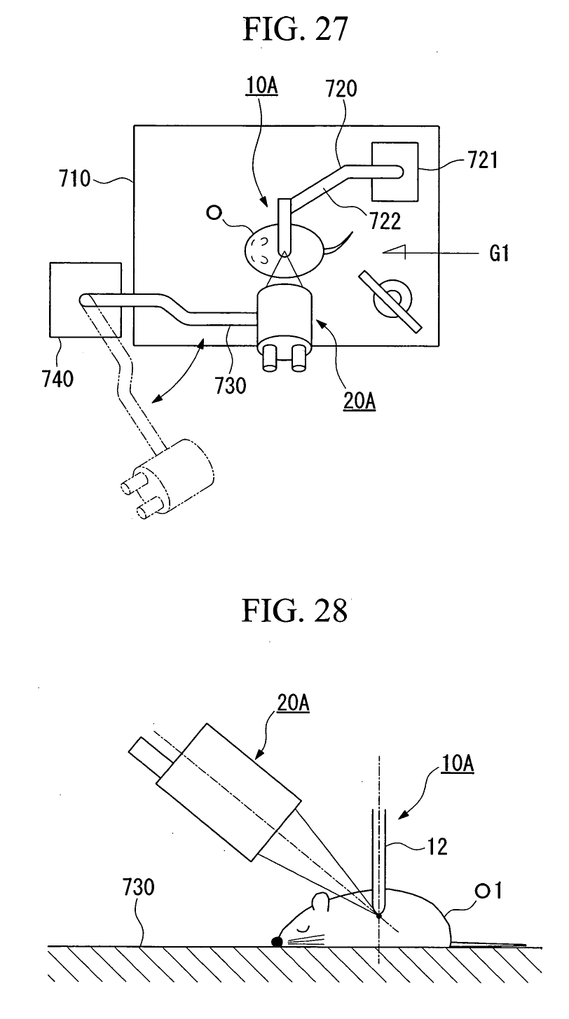

The twelfth embodiment of the present invention will now be described referring to FIG. 27 and FIG. 28. FIG. 27 is a plan view showing the microscopic observing apparatus of the present embodiment. FIG. 28 is a view showing a portion of this microscopic observing apparatus, and is a side view looking from the direction of the arrow G1 shown in FIG. 27.

Note that in the description below, component elements that are the same as those in the fifth embodiment are given the same reference symbols and a detailed description thereof is omitted.

As is shown in FIG. 27, the microscopic observing apparatus of the present embodiment is provided with the probe microscope 10A that has a relatively high magnification optical system, the stereoscopic microscope (i.e., an auxiliary microscope) 20A that has a low magnification optical system, a specimen stage 710 on which is placed a subject of observation O1 such as an experimental animal that is to be observed using the probe microscope 10A and the stereoscopic microscope 20A, a microscope holding mechanism (i.e., a fourth microscope holding member) 720 that holds the probe microscope 10A and that allows the optical axis position of the probe microscope 10A to be adjusted relative to a predetermined position (for example, a center position on the placement surface) on the specimen stage 710, an arm (i.e., a fifth microscope holding member) 730 that holds the stereoscopic microscope 20A, a θ stage (i.e., a rotating mechanism) 740 that supports the arm 730 such that it can rotate around a vertical axis, and a stopper (not shown) that stops a rotation of the arm 730 when the arm 730 is rotated by the θ stage 730 and the optical axis of the stereoscopic microscope 20A matches the predetermined position.

The microscope holding mechanism 720 is provided with an XYZ stage 721, and an arm 722 that extends horizontally towards the predetermined position from the top of the XYZ stage 721 and that holds the probe microscope 10A at the distal end thereof. It is possible to precisely adjust the position of the distal end of the probe 12 relative to the predetermined position using the XYZ stage 721.

As is shown in FIG. 28, the arm 730 holds the stereoscopic microscope 20A on an inclination such that the optical axis thereof intersects the optical axis of the probe microscope 10A. As a result, it is possible to easily confirm the position of the distal end of the probe 12 via the field of vision of the stereoscopic microscope 20A.

An observation method for observing the subject of observation O1 using the microscopic observing apparatus of the present embodiment having the above described structure will now be described.

Firstly, the arm 730 is rotated such that the optical axis of the stereoscopic microscope 20A is directed towards the predetermined position. At the point when the optical axis of the stereoscopic microscope 20A matches the predetermined position, the stopper is operated so that further rotation of the arm 730 is stopped. Macro observation of the subject of observation O1 on the specimen stage 710 is then performed using the stereoscopic microscope 20A that has been positioned in this manner.

The XYZ stage 721 is then operated while the relative positions between the observation position of the subject of observation O1 in the visual field of the stereoscopic microscope 20A and the probe microscope 10A are being confirmed from an oblique angle, as is shown in FIG. 28, and the optical axis position of the probe microscope 10A is matched to the observation position. At this time, because the position of the distal end of the probe microscope 10A can be viewed using an auxiliary microscope such that it can be viewed from an oblique angle, the positioning operation can be performed easily.

Next, micro observation is performed using the probe microscope 10A. If necessary, by releasing the fixing action of the stopper and rotating the θ stage 740, it is possible to withdraw the arm 730 together with the stereoscopic microscope 20A from above the specimen stage 710. In this state, micro observation using the probe microscope 10 is performed.

Note that, in the present embodiment, a structure is employed in which, when positioning the optical axis of the probe microscope 10A, the adjustment can be made while viewing the position of the distal end of the probe 12, however, the present embodiment is not limited to this and it is also possible to employ a structure in which the laser pointer adapters 610 and 630 described in the eleventh embodiment are mounted on a distal end of the probe 12, and positioning is performed by confirming the irradiation position of laser light on the subject of observation O1. At this time, if the subject of observation O1 is a fluorescent sample, then by using an excitation wavelength for the wavelength of the laser light, it is possible to perform positioning using fluorescent observation in addition to normal observation.

According to the above described microscopic observing apparatus of the present embodiment, because the position of the distal end of the probe microscope 10A can be viewed using the stereoscopic microscope 20A such that it can be viewed from an oblique angle, the positioning operation can be performed easily. Accordingly, when switching from macro observation to micro observation using the probe microscope 10A having a relatively high magnification optical system and the stereoscopic microscope 20A having a low magnification optical system, the probe microscope 10A can be easily and accurately positioned at the desired observation position.

During the micro observation using the probe microscope 10A, if necessary, it is possible to withdraw the arm 730 together with the stereoscopic microscope 20A from above the subject of observation O1. Accordingly, during micro observation it is possible to secure a large working space.

Note that, in the present embodiment, a stereoscopic microscope 20A is employed as the auxiliary microscope having a relatively low magnification optical system relative to the probe microscope 10A, however, the present embodiment is not limited to this and, as is shown in FIG. 15, for example, it is also possible to use a normal microscope 20A1 instead.

Furthermore, in the present embodiment a structure is employed in which the position of the distal end of the probe 12 is confirmed by placing the stereoscopic microscope 20A at an oblique angle at the side of the probe microscope 10A, however, the present embodiment is not limited to this and is also possible to employ a structure in which the stereoscopic microscope 20A is placed at a position directly above the probe microscope 10A.

Specifically, although not shown in the drawings, it is possible to employ a structure in which there are provided the microscope holding mechanism 720 (i.e., a sixth microscope holding member) that holds the probe microscope 10A and that allows the optical axis position of the probe microscope 10A to be adjusted relative to the predetermined position on the specimen stage 710, the arm 730 (i.e., a seventh microscope holding member) that holds the stereoscopic microscope 20A such that it can be rotated so as to pass through a position above the probe microscope 10A that is placed at the predetermined position, and the stopper (i.e., a seventh restricting member) that stops the rotation of the arm 730 when the optical axis of the stereoscopic microscope 20A matches the predetermined position. In this case, when both the stereoscopic microscope 20A and the probe microscope 10A are placed above the predetermined position, the probe microscope 10A is placed within the dead angle region of the stereoscopic microscope 20A.

If this type of structure is employed, firstly, the arm 730 is rotated such that the optical axis of the stereoscopic microscope 20A is directed towards the predetermined position. At the point when the optical axis of the stereoscopic microscope 20A matches the predetermined position, the stopper is operated so that further rotation of the arm 730 is stopped. Subsequently, because the probe 12 of the probe microscope 10A is automatically hidden in the dead angle region of the stereoscopic microscope 20A, macro observation using the stereoscopic microscope 20A can be performed without the field of vision being obstructed.

Next, micro observation using the probe microscope 10A is performed. In this case, when the probe microscope 10A is lowered using the XYZ stage 721 so as to approach the observation position on the subject of observation O1, the distal end of the probe microscope 10A is taken out of the dead angle region and appears within the field of vision of the stereoscopic microscope 20A. Therefore, by positioning the probe microscope 10A while confirming the position of the distal end of the probe 12 using the field of vision of the stereoscopic microscope 20A, it is possible to set the optical axis position of the probe microscope 10A.

Note that, in this case is well, during the micro observation using the probe microscope 10A, because it is possible to withdraw the arm 730 together with the stereoscopic microscope 20A from above the specimen stage 710, it is possible to secure a large working space.

Note also that the probe microscope 10A of the above described fifth through twelfth embodiments is a direct view type of microscope that performs observation in the axial direction of the probe 12, the present intention is not limited to this, and it is also possible to employ a side view type of microscope that observes a right angle direction relative to the axial direction of the probe 12. In this case, by rotating the probe 12 around the axis thereof it is possible to perform observation over at a broader range.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A microscopic observing apparatus comprising:
a probe microscope and
a stereoscopic microscope,
wherein an optical axis of the probe microscope is placed between two optical axes of the stereoscopic microscope.

2. The microscopic observing apparatus according to claim 1, wherein a probe body housing an optical system of the probe microscope is supported by a first supporting member that avoids the two optical axes of the stereoscopic microscope.

3. The microscopic observing apparatus according to claim 1, wherein a probe body housing an optical system of the probe microscope is supported by a second supporting member that is formed from a transparent material.

4. A probe microscope that is used in combination with a stereoscopic microscope, wherein
an optical axis of the probe microscope is positioned between two optical axes of the stereoscopic microscope.

5. A microscopic observing apparatus comprising:
a probe microscope;
an auxiliary microscope;
a specimen stage on which is placed a subject of observation that is to be observed using the probe microscope and the auxiliary microscope, and that allows an absolute position of the subject of observation to be adjusted;
a first guide that guides the probe microscope and the auxiliary microscope in one direction above the specimen stage;
a connecting member that maintains a constant spacing between optical axes of the probe microscope and the auxiliary microscope;
a first restricting member that restricts further movement of the auxiliary microscope when a position of an optical axis of the auxiliary microscope matches a predetermined position on the first guide; and
a second restricting member that restricts further movement of the probe microscope when a position of an optical axis of the probe microscope matches the predetermined position.

6. A microscopic observing apparatus comprising:
a probe microscope;
an auxiliary microscope;
a specimen stage on which is placed a subject of observation that is to be observed using the probe microscope and the auxiliary microscope, and that allows an absolute position of the subject of observation to be adjusted;
a first microscope holding member that holds the auxiliary microscope and the probe microscope such that they can be rotated so as to pass above the specimen stage; and
a third restricting member that restricts further rotation of the auxiliary microscope when an optical axis position of the auxiliary microscope matches a predetermined position on the specimen stage, and that restricts further rotation of the probe microscope when an optical axis position of the probe microscope matches the predetermined position.

7. A microscopic observing apparatus comprising:
a probe microscope;
an auxiliary microscope;
a specimen stage on which is placed a subject of observation that is to be observed using the probe microscope and the auxiliary microscope, and that allows an absolute position of the subject of observation to be adjusted;
a second guide that extends between the probe microscope and the auxiliary microscope;
a fourth restricting member that restricts further movement of the specimen stage when a predetermined position on the specimen stage arrives at an optical axis position of the auxiliary microscope; and
a fifth restricting member that restricts further movement of the specimen stage when the predetermined position on the specimen stage arrives at an optical axis position of the probe microscope,
wherein the specimen stage has a rough movement stage that moves along the second guide, and a precise movement stage those relative position relative to the rough movement stage can be precisely adjusted and on which the subject of observation is placed, and
the predetermined position is set for the rough movement stage.

8. The microscopic observing apparatus according to claim 7, wherein an aperture portion that penetrates the specimen stage in a vertical direction is formed in the specimen stage, and the probe microscope and the stereoscopic microscope are able to observe the subject of observation from the underside of the specimen stage via the aperture portion.

9. A microscopic observing apparatus comprising:
a probe microscope;
an auxiliary microscope;
a specimen stage on which is placed a subject of observation that is to be observed using the probe microscope and the auxiliary microscope,
wherein an aperture portion that penetrates the specimen stage in a vertical direction is formed in the specimen stage, and
the microscopic observing apparatus is provided with: a second microscope holding member that holds the probe microscope and the auxiliary microscope below the specimen stage such that optical axes of the probe microscope and the auxiliary microscope penetrate the aperture portion and intersect at a position on the subject of observation; and an adjusting device that adjusts relative positions between the specimen stage and the auxiliary microscope and probe microscope.

10. The microscopic observing apparatus according to claim 5, wherein the microscopic observing apparatus is provided with a first laser light irradiation device that irradiates laser light onto a position where the optical axis of the auxiliary microscope strikes the subject of observation.

11. A microscopic observing apparatus comprising:
a probe microscope;
an auxiliary microscope;
a specimen stage on which is placed a subject of observation that is to be observed using the probe microscope and the auxiliary microscope, and that allows an absolute position of the subject of observation to be adjusted; and
a second laser light irradiation device that irradiates laser light that is coaxial with the optical axis of the probe microscope onto the subject of observation,
wherein the auxiliary microscope is located such that the laser light irradiated onto the subject of observation is visible.

12. The microscopic observing apparatus according to claim 11, wherein the auxiliary microscope is a video microscope including a CCD camera with a macro lens, and that is held together with the probe microscope by a third microscope holding member.

13. The microscopic observing apparatus according to claim 10, wherein when the subject of observation is a fluorescent sample, an excitation wavelength is used for the wavelength of the laser light.

14. A microscopic observing apparatus comprising:
a probe microscope;
an auxiliary microscope;
a specimen stage on which is placed a subject of observation that is to be observed using the probe microscope and the auxiliary microscope;
a fourth microscope holding member that holds the probe microscope and that allows a position of an optical axis of the probe microscope to be adjusted relative to a predetermined position on the specimen stage;
a fifth microscope holding member that holds the auxiliary microscope such that an optical axis of the auxiliary microscope intersects with an optical axis of the probe microscope;
a rotation mechanism that rotatably supports the fifth microscope holding member; and
a sixth restricting member that stops a rotation of the fifth microscope holding member when the fifth microscope holding member is rotated by the rotation mechanism and an optical axis of the auxiliary microscope matches the predetermined position.

15. A microscopic observing apparatus comprising:
a probe microscope;
an auxiliary microscope;
a specimen stage on which is placed a subject of observation that is to be observed using the probe microscope and the auxiliary microscope;
a sixth microscope holding member that holds the probe microscope and that allows a position of an optical axis of the probe microscope to be adjusted relative to a predetermined position on the specimen stage;
a seventh microscope holding member that holds the auxiliary microscope such that it can be rotated so as to pass through a position above the probe microscope that is placed at the predetermined position; and
a seventh restricting member that stops a rotation of the seventh microscope holding member when an optical axis of the auxiliary microscope matches the predetermined position,
wherein the auxiliary microscope is a stereoscopic microscope, and
when the stereoscopic microscope and the probe microscope are both placed above the predetermined position, the probe microscope is placed within a dead angle region of the stereoscopic microscope.
